(19) United States
(12) Patent Application Publication
(10) Pub. No.: US 2026/0051138 A1
(43) Pub. Date: Feb. 19, 2026

(54) APPARATUS AND METHOD FOR DETECTING WRONG-WAY DRIVING VEHICLE BASED ON OBJECT IMAGE ANALYSIS OR COLOR HISTOGRAM ANALYSIS

(71) Applicant: SK Planet Co., Ltd., Seongnam-si (KR)

(72) Inventors: Joon Sung LEE, Seoul (KR); Jong Hee JUNG, Yongin-si (KR)

(21) Appl. No.: 18/802,553

(22) Filed: Aug. 13, 2024

(30) Foreign Application Priority Data
Aug. 16, 2023 (KR) 10-2023-0107287
Aug. 16, 2023 (KR) 10-2023-0107289
Aug. 24, 2023 (KR) 10-2023-0111425

(51) Int. Cl. G06V 10/25; G06T 5/40; G06T 7/20; G06V 10/764; G06V 20/70

(52) U.S. Cl. CPC G06V 10/25; G06T 5/40; G06T 7/20; G06V 10/764; G06V 20/70; G06T 2207/30252; G06V 2201/07

(57) ABSTRACT

Embodiments relate to an apparatus and method for detecting or tracking a wrong-way driving vehicle based on object image analysis or color histogram analysis. The detection or tracking of a wrong-way driving vehicle uses at least one of an object detection model, a classification model, and an anomaly detection model.

### CROSS-REFERENCE TO RELATED APPLICATIONS

This application claims the benefit of priority to Republic of Korea Patent Application Nos. 10-2023-0107287, filed on Aug. 16, 2023, 10-2023-0107289, filed on Aug. 16, 2023, and 10-2023-0111425, filed on Aug. 24, 2023, which are incorporated by reference herein in their entirety.

### TECHNICAL FIELD

The present disclosure relates to an apparatus and method for detecting a wrong-way driving vehicle based on object image analysis or color histogram analysis.

### BACKGROUND ART

Wrong-way driving, also known as contraflow driving, is the act of driving a motor vehicle against the direction of traffic. It can occur on either one- or two-way roads, as well as in parking lots and parking garages, and may be due to driver inattention or impairment, or because of insufficient or confusing road markings or signage, or a driver from a right-hand traffic country being unaccustomed to driving in a left-hand traffic country, and vice versa.

Wrong-way driving is particularly dangerous on a divided highway, especially a freeway. The higher speeds typical of such roads mean that wrong-way driving invariably leads to a head-on collision. One of the aims of highway engineering is to reduce wrong-way driving. Therefore, many nations have made great efforts to combat this issue, especially in the recent years.

### SUMMARY

Accordingly, the present disclosure is intended to provide an apparatus and method for detecting a wrong-way driving vehicle based on object image analysis or color histogram analysis.

According to an embodiment of the present disclosure, a method for detecting a wrong-way driving vehicle is provided. The method may include, by a data processor, receiving an image of a vehicle; by an object detector, deriving a bounding box image, which is an image of a bounding box indicating an area occupied by the vehicle in the received image, using a learned object detection model; by a wrong-way driving detector, analyzing the bounding box image using a learned classification model to derive a first determination result indicating whether the vehicle is a wrong-way driving vehicle; by the wrong-way driving detector, analyzing the bounding box image using a learned anomaly detection model to derive a second determination result indicating whether the vehicle is a wrong-way driving vehicle; and by the wrong-way driving detector, considering both the first determination result and the second determination result to derive a final determination result indicating whether the vehicle is a wrong-way driving vehicle.

In the method, deriving the bounding box image may include, by the learned object detection model, performing a plurality of operations for applying a plurality of learned inter-layer weights to the received image to detect the bounding box; and by the object detector, extracting the bounding box image from the received image.

In the method, deriving the first determination result may include, by the learned classification model, performing a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle; and by the wrong-way driving detector, deriving the first determination result based on both the probability of a normal driving vehicle and the probability of a wrong-way driving vehicle in the classification value.

In the method, deriving the second determination result may include, by the learned anomaly detection model, performing a plurality of operations for applying a plurality of learned inter-layer weights to the bounding box image to compress and restore the bounding box image and thereby derive a simulated image that simulates the bounding box image; by the wrong-way driving detector, calculating a restoration loss indicating a difference between the bounding box image and the simulated image; and by the wrong-way driving detector, deriving the second determination result based on whether the calculated restoration loss is less than a predetermined threshold.

The method may further include, before receiving the image of the vehicle, by a learning unit, preparing learning data including a learning image and a label, the learning image containing a vehicle object, and the label including a ground-truth box indicating an area occupied by the vehicle object in the learning image and a class vector indicating that a class of the object is a vehicle; by the learning unit, inputting the learning image into an object detection model whose learning is uncompleted; by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs; by the learning unit, calculating a composite loss including a difference between the bounding box and the ground-truth box and a difference between the class vector and the predictive vector; and by the learning unit, performing optimization to modify the weights of the object detection model so that the composite loss is minimized.

The method may further include, before receiving the image of the vehicle, by a learning unit, preparing learning data including a learning image and a label, the learning image containing a normal driving vehicle or a wrong-way driving vehicle, and the label distinguishing whether a vehicle in the learning image is a normal driving vehicle or a wrong-way driving vehicle; by the learning unit, inputting the learning image into a classification model whose learning is uncompleted; by the classification model, performing a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle; by the learning unit, calculating a classification loss indicating a difference between the learning classification value and the label; and by the learning unit, performing optimization to modify the weights of the classification model so that the classification loss is minimized.

The method may further include, before receiving the image of the vehicle, by a learning unit, preparing a learning image containing a normal driving vehicle; by the learning unit, inputting the learning image into an anomaly detection model whose learning is uncompleted; by the anomaly detection model, performing a plurality of operations for applying untrained inter-layer weights to the learning image to generate a simulated image that simulates the learning image; by the learning unit, calculating a restoration loss indicating a difference between the learning image and the simulated image; and by the learning unit, performing optimization to modify the weights of the anomaly detection model so that the restoration loss is minimized.

The method may further include, before receiving the image of the vehicle and after performing the optimization, by the learning unit, calculating a threshold value according to Equation θ=μ+(k×σ), wherein μ denotes an average of the mean squared error between a plurality of test images and a plurality of simulated images corresponding to the plurality of test images, σ denotes a standard deviation of the mean squared error between a plurality of test images and a plurality of simulated images corresponding to the plurality of test images, and k denotes a weight for the standard deviation.

According to an embodiment of the present disclosure, an apparatus for detecting a wrong-way driving vehicle is provided. The apparatus may include a data processor configured to receive an image of a vehicle; an object detector configured to derive a bounding box image, which is an image of a bounding box indicating an area occupied by the vehicle in the received image, using a learned object detection model; and a wrong-way driving detector configured to analyze the bounding box image using a learned classification model to derive a first determination result indicating whether the vehicle is a wrong-way driving vehicle, to analyze the bounding box image using a learned anomaly detection model to derive a second determination result indicating whether the vehicle is a wrong-way driving vehicle, and to consider both the first determination result and the second determination result to derive a final determination result indicating whether the vehicle is a wrong-way driving vehicle.

In the apparatus, the learned object detection model may perform a plurality of operations for applying a plurality of learned inter-layer weights to the received image to detect the bounding box, and the object detector may be configured to extract the bounding box image from the received image.

In the apparatus, the learned classification model may perform a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle, and the wrong-way driving detector may be configured to derive the first determination result based on both the probability of a normal driving vehicle and the probability of a wrong-way driving vehicle in the classification value.

In the apparatus, the learned anomaly detection model may perform a plurality of operations for applying a plurality of learned inter-layer weights to the bounding box image to compress and restore the bounding box image and thereby derive a simulated image that simulates the bounding box image, and the wrong-way driving detector may be configured to calculate a restoration loss indicating a difference between the bounding box image and the simulated image, and to derive the second determination result based on whether the calculated restoration loss is less than a predetermined threshold.

The apparatus may further include a learning unit configured to prepare learning data including a learning image and a label, the learning image containing a vehicle object, and the label including a ground-truth box indicating an area occupied by the vehicle object in the learning image and a class vector indicating that a class of the object is a vehicle, to input the learning image into an object detection model whose learning is uncompleted, when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs, to calculate a composite loss including a difference between the bounding box and the ground-truth box and a difference between the class vector and the predictive vector, and to perform optimization to modify the weights of the object detection model so that the composite loss is minimized.

The apparatus may further include a learning unit configured to prepare learning data including a learning image and a label, the learning image containing a normal driving vehicle or a wrong-way driving vehicle, and the label distinguishing whether a vehicle in the learning image is a normal driving vehicle or a wrong-way driving vehicle, to input the learning image into a classification model whose learning is uncompleted, when the classification model performs a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle, to calculate a classification loss indicating a difference between the learning classification value and the label, and to perform optimization to modify the weights of the classification model so that the classification loss is minimized.

The apparatus may further include a learning unit configured to prepare a learning image containing a normal driving vehicle, to input the learning image into an anomaly detection model whose learning is uncompleted, when the anomaly detection model performs a plurality of operations for applying untrained inter-layer weights to the learning image to generate a simulated image that simulates the learning image, to calculate a restoration loss indicating a difference between the learning image and the simulated image, and to perform optimization to modify the weights of the anomaly detection model so that the restoration loss is minimized.

In the apparatus, the learning unit may calculate a threshold value according to Equation θ=μ+(k×σ), wherein μ denotes an average of the mean squared error between a plurality of test images and a plurality of simulated images corresponding to the plurality of test images, σ denotes a standard deviation of the mean squared error between a plurality of test images and a plurality of simulated images corresponding to the plurality of test images, and k denotes a weight for the standard deviation.

According to an embodiment of the present disclosure, a method for tracking a wrong-way driving vehicle is provided. The method may include, by a data processor, receiving an image from a first sensor device among a plurality of sensor devices arranged at predetermined intervals along a road and including the first sensor device and a plurality of second sensor devices; by a tracking unit, analyzing the image received from the first sensor device to determine whether a wrong-way driving vehicle is detected in the received image; by the tracking unit, when the wrong-way driving vehicle is detected in the received image, receiving images from the plurality of second sensor devices through the data processor; and by the tracking unit, analyzing the images received from the plurality of second sensor devices to continuously detect the wrong-way driving vehicle, thereby tracking the wrong-way driving vehicle.

In the method, tracking the wrong-way driving vehicle may include, by the tracking unit, receiving the images from one or more second sensor devices in the order of proximity to the first sensor device among the plurality of second sensor devices arranged in a direction of travel of the wrong-way driving vehicle; and by the tracking unit, analyzing the images received from the one or more second sensor devices through one or more learning models to detect the wrong-way driving vehicle in the received images.

In the method, determining whether a wrong-way driving vehicle is detected may include, by an object detector, deriving a bounding box image, which is an image of a bounding box indicating an area occupied by the vehicle in the received image, using a learned object detection model; by a wrong-way driving detector, analyzing the bounding box image using a learned classification model to derive a first determination result indicating whether the vehicle is a wrong-way driving vehicle; by the wrong-way driving detector, analyzing the bounding box image using a learned anomaly detection model to derive a second determination result indicating whether the vehicle is a wrong-way driving vehicle; and by the wrong-way driving detector, considering both the first determination result and the second determination result to derive a final determination result indicating whether the vehicle is a wrong-way driving vehicle.

In the method, deriving the bounding box image may include, by the learned object detection model, performing a plurality of operations for applying a plurality of learned inter-layer weights to the received image to detect the bounding box; and by the object detector, extracting the bounding box image from the received image.

In the method, deriving the first determination result may include, by the learned classification model, performing a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle; and by the wrong-way driving detector, deriving the first determination result based on both the probability of a normal driving vehicle and the probability of a wrong-way driving vehicle in the classification value.

In the method, deriving the second determination result may include, by the learned anomaly detection model, performing a plurality of operations for applying a plurality of learned inter-layer weights to the bounding box image to compress and restore the bounding box image and thereby derive a simulated image that simulates the bounding box image; by the wrong-way driving detector, calculating a restoration loss indicating a difference between the bounding box image and the simulated image; and by the wrong-way driving detector, deriving the second determination result based on whether the calculated restoration loss is less than a predetermined threshold.

The method may further include, before receiving the image of the vehicle, by a learning unit, preparing learning data including a learning image and a label, the learning image containing a vehicle object, and the label including a ground-truth box indicating an area occupied by the vehicle object in the learning image and a class vector indicating that a class of the object is a vehicle; by the learning unit, inputting the learning image into an object detection model whose learning is uncompleted; by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs; by the learning unit, calculating a composite loss including a difference between the bounding box and the ground-truth box and a difference between the class vector and the predictive vector; and by the learning unit, performing optimization to modify the weights of the object detection model so that the composite loss is minimized.

The method may further include, before receiving the image of the vehicle, by a learning unit, preparing learning data including a learning image and a label, the learning image containing a normal driving vehicle or a wrong-way driving vehicle, and the label distinguishing whether a vehicle in the learning image is a normal driving vehicle or a wrong-way driving vehicle; by the learning unit, inputting the learning image into a classification model whose learning is uncompleted; by the classification model, performing a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle; by the learning unit, calculating a classification loss indicating a difference between the learning classification value and the label; and by the learning unit, performing optimization to modify the weights of the classification model so that the classification loss is minimized.

The method may further include, before receiving the image of the vehicle, by a learning unit, preparing a learning image containing a normal driving vehicle; by the learning unit, inputting the learning image into an anomaly detection model whose learning is uncompleted; by the anomaly detection model, performing a plurality of operations for applying untrained inter-layer weights to the learning image to generate a simulated image that simulates the learning image; by the learning unit, calculating a restoration loss indicating a difference between the learning image and the simulated image; and by the learning unit, performing optimization to modify the weights of the anomaly detection model so that the restoration loss is minimized.

The method may further include, before receiving the image of the vehicle and after performing the optimization, by the learning unit, calculating a threshold value according to Equation θ=μ+(k×σ), wherein μ denotes an average of the mean squared error between a plurality of test images and a plurality of simulated images corresponding to the plurality of test images, σ denotes a standard deviation of the mean squared error between a plurality of test images and a plurality of simulated images corresponding to the plurality of test images, and k denotes a weight for the standard deviation.

According to an embodiment of the present disclosure, an apparatus for tracking a wrong-way driving vehicle is provided. The apparatus may include a data processor configured to receive an image from a first sensor device among a plurality of sensor devices arranged at predetermined intervals along a road and including the first sensor device and a plurality of second sensor devices; and a tracking unit configured to analyze the image received from the first sensor device to determine whether a wrong-way driving vehicle is detected in the received image, when the wrong-way driving vehicle is detected in the received image, to receive images from the plurality of second sensor devices through the data processor, and to analyze the images received from the plurality of second sensor devices to continuously detect the wrong-way driving vehicle, thereby tracking the wrong-way driving vehicle.

In the apparatus, the tracking unit may be configured to receive the images from one or more second sensor devices in the order of proximity to the first sensor device among the plurality of second sensor devices arranged in a direction of travel of the wrong-way driving vehicle, and to analyze the images received from the one or more second sensor devices through one or more learning models to detect the wrong-way driving vehicle in the received images.

In the apparatus, the tracking unit may include an object detector configured to derive a bounding box image, which is an image of a bounding box indicating an area occupied by the vehicle in the received image, using a learned object detection model; and a wrong-way driving detector configured to analyze the bounding box image using a learned classification model to derive a first determination result indicating whether the vehicle is a wrong-way driving vehicle, to analyze the bounding box image using a learned anomaly detection model to derive a second determination result indicating whether the vehicle is a wrong-way driving vehicle, and to consider both the first determination result and the second determination result to derive a final determination result indicating whether the vehicle is a wrong-way driving vehicle.

In the apparatus, the learned object detection model may perform a plurality of operations for applying a plurality of learned inter-layer weights to the received image to detect the bounding box, and the object detector may be configured to extract the bounding box image from the received image.

In the apparatus, the learned classification model may perform a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle, and the wrong-way driving detector may be configured to derive the first determination result based on both the probability of a normal driving vehicle and the probability of a wrong-way driving vehicle in the classification value.

In the apparatus, the learned anomaly detection model may perform a plurality of operations for applying a plurality of learned inter-layer weights to the bounding box image to compress and restore the bounding box image and thereby derive a simulated image that simulates the bounding box image, and the wrong-way driving detector may be configured to calculate a restoration loss indicating a difference between the bounding box image and the simulated image, and to derive the second determination result based on whether the calculated restoration loss is less than a predetermined threshold.

The apparatus may further include a learning unit configured to prepare learning data including a learning image and a label, the learning image containing a vehicle object, and the label including a ground-truth box indicating an area occupied by the vehicle object in the learning image and a class vector indicating that a class of the object is a vehicle, to input the learning image into an object detection model whose learning is uncompleted, when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs, to calculate a composite loss including a difference between the bounding box and the ground-truth box and a difference between the class vector and the predictive vector, and to perform optimization to modify the weights of the object detection model so that the composite loss is minimized.

The apparatus may further include a learning unit configured to prepare learning data including a learning image and a label, the learning image containing a normal driving vehicle or a wrong-way driving vehicle, and the label distinguishing whether a vehicle in the learning image is a normal driving vehicle or a wrong-way driving vehicle, to input the learning image into a classification model whose learning is uncompleted, when the classification model performs a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle, to calculate a classification loss indicating a difference between the learning classification value and the label, and to perform optimization to modify the weights of the classification model so that the classification loss is minimized.

The apparatus may further include a learning unit configured to prepare a learning image containing a normal driving vehicle, to input the learning image into an anomaly detection model whose learning is uncompleted, when the anomaly detection model performs a plurality of operations for applying untrained inter-layer weights to the learning image to generate a simulated image that simulates the learning image, to calculate a restoration loss indicating a difference between the learning image and the simulated image, and to perform optimization to modify the weights of the anomaly detection model so that the restoration loss is minimized.

In the apparatus, the learning unit may calculate a threshold value according to Equation θ=μ+(k×σ), wherein μ denotes an average of the mean squared error between a plurality of test images and a plurality of simulated images corresponding to the plurality of test images, σ denotes a standard deviation of the mean squared error between a plurality of test images and a plurality of simulated images corresponding to the plurality of test images, and k denotes a weight for the standard deviation.

According to an embodiment of the present disclosure, a method for detecting a wrong-way driving vehicle is provided. The method may include, by a data processor, receiving an image of a vehicle driving a road; by an object detector, deriving a bounding box image, which is an image of a bounding box indicating an area occupied by the vehicle in the received image, using a learned object detection model; by a histogram generator, deriving a color histogram from the bounding box image; and by a wrong-way driving detector, identifying a difference in color distribution between a front and rear of the vehicle through analysis of the color histogram to determine whether the vehicle is a wrong-way driving vehicle.

In the method, determining whether the vehicle is a wrong-way driving vehicle may include, by the wrong-way driving detector, analyzing the color histogram using a learned classification model to derive a first determination result indicating whether the vehicle is a wrong-way driving vehicle; by the wrong-way driving detector, analyzing the color histogram using a learned anomaly detection model to derive a second determination result indicating whether the vehicle is a wrong-way driving vehicle; and by the wrong-way driving detector, considering both the first determination result and the second determination result to derive a final determination result indicating whether the vehicle is a wrong-way driving vehicle.

In the method, deriving the first determination result may include, by the learned classification model, performing a plurality of operations for applying a plurality of learned inter-layer weights to the color histogram to calculate a classification value indicating a probability that the vehicle in the bounding box image is a normal driving vehicle and a probability that the vehicle in the bounding box image is a wrong-way driving vehicle; and by the wrong-way driving detector, deriving the first determination result based on both the probability of a normal driving vehicle and the probability of a wrong-way driving vehicle in the classification value.

In the method, deriving the second determination result may include, by the learned anomaly detection model, performing a plurality of operations for applying a plurality of learned inter-layer weights to the color histogram to compress and restore the bounding box image and thereby derive a simulated color histogram that simulates the color histogram; by the wrong-way driving detector, calculating a restoration loss indicating a difference between the color histogram and the simulated color histogram; and by the wrong-way driving detector, deriving the second determination result based on whether the calculated restoration loss is less than a predetermined threshold.

In the method, deriving the bounding box image may include, by the learned object detection model, performing a plurality of operations for applying a plurality of learned inter-layer weights to the received image to detect the bounding box; and by the object detector, extracting the bounding box image from the received image.

The method may further include, before receiving the image of the vehicle, by a learning unit, preparing learning data including a learning color histogram of an image containing a normal driving vehicle or a wrong-way driving vehicle, the learning data further including a label distinguishing whether a vehicle in the learning color histogram is a normal driving vehicle or a wrong-way driving vehicle; by the learning unit, inputting the learning color histogram into a classification model whose learning is uncompleted; by the classification model, performing a plurality of operations for applying untrained inter-layer weights to the learning color histogram to calculate a learning classification value indicating a probability that the vehicle in the learning color histogram is a normal driving vehicle and a probability that the vehicle in the learning color histogram is a wrong-way driving vehicle; by the learning unit, calculating a classification loss indicating a difference between the learning classification value and the label; and by the learning unit, performing optimization to modify the weights of the classification model so that the classification loss is minimized.

The method may further include, before receiving the image of the vehicle, by a learning unit, preparing a learning color histogram of an image containing a normal driving vehicle; by the learning unit, inputting the learning color histogram into an anomaly detection model whose learning is uncompleted; by the anomaly detection model, performing a plurality of operations for applying untrained inter-layer weights to the learning color histogram to generate a simulated color histogram that simulates the learning color histogram; by the learning unit, calculating a restoration loss indicating a difference between the learning color histogram and the simulated color histogram; and by the learning unit, performing optimization to modify the weights of the anomaly detection model so that the restoration loss is minimized.

The method may further include, before receiving the image of the vehicle and after performing the optimization, by the learning unit, calculating a threshold value according to Equation θ=μ+(k×σ), wherein μ denotes an average of the mean squared error between a plurality of test color histograms and a plurality of simulated color histograms corresponding to the plurality of test color histograms, σ denotes a standard deviation of the mean squared error between a plurality of test color histograms and a plurality of simulated color histograms corresponding to the plurality of test color histograms, and k denotes a weight for the standard deviation.

The method may further include, before receiving the image of the vehicle, by a learning unit, preparing learning data including a learning image and a label, the learning image containing a vehicle object, and the label including a ground-truth box indicating an area occupied by the vehicle object in the learning image and a class vector indicating that a class of the object is a vehicle; by the learning unit, inputting the learning image into an object detection model whose learning is uncompleted; by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs; by the learning unit, calculating a composite loss including a difference between the bounding box and the ground-truth box and a difference between the class vector and the predictive vector; and by the learning unit, performing optimization to modify the weights of the object detection model so that the composite loss is minimized.

According to an embodiment of the present disclosure, an apparatus for detecting a wrong-way driving vehicle is provided. The apparatus may include a data processor configured to receive an image of a vehicle driving a road; an object detector configured to derive a bounding box image, which is an image of a bounding box indicating an area occupied by the vehicle in the received image, using a learned object detection model; a histogram generator configured to derive a color histogram from the bounding box image; and a wrong-way driving detector configured to identify a difference in color distribution between a front and rear of the vehicle through analysis of the color histogram to determine whether the vehicle is a wrong-way driving vehicle.

In the apparatus, the wrong-way driving detector may be configured to analyze the color histogram using a learned classification model to derive a first determination result indicating whether the vehicle is a wrong-way driving vehicle, to analyze the color histogram using a learned anomaly detection model to derive a second determination result indicating whether the vehicle is a wrong-way driving vehicle, and to consider both the first determination result and the second determination result to derive a final determination result indicating whether the vehicle is a wrong-way driving vehicle.

In the apparatus, the learned classification model may perform a plurality of operations for applying a plurality of learned inter-layer weights to the color histogram to calculate a classification value indicating a probability that the vehicle in the bounding box image is a normal driving vehicle and a probability that the vehicle in the bounding box image is a wrong-way driving vehicle, and the wrong-way driving detector may be configured to derive the first determination result based on both the probability of a normal driving vehicle and the probability of a wrong-way driving vehicle in the classification value.

In the apparatus, the learned anomaly detection model may perform a plurality of operations for applying a plurality of learned inter-layer weights to the color histogram to compress and restore the bounding box image and thereby derive a simulated color histogram that simulates the color histogram, and the wrong-way driving detector may be configured to calculate a restoration loss indicating a difference between the color histogram and the simulated color histogram, and to derive the second determination result based on whether the calculated restoration loss is less than a predetermined threshold.

In the apparatus, the learned object detection model may perform a plurality of operations for applying a plurality of learned inter-layer weights to the received image to detect the bounding box, and the object detector may be configured to extract the bounding box image from the received image.

The apparatus may further include a learning unit configured to prepare learning data including a learning color histogram of an image containing a normal driving vehicle or a wrong-way driving vehicle, the learning data further including a label distinguishing whether a vehicle in the learning color histogram is a normal driving vehicle or a wrong-way driving vehicle, to input the learning color histogram into a classification model whose learning is uncompleted, when the classification model performs a plurality of operations for applying untrained inter-layer weights to the learning color histogram to calculate a learning classification value indicating a probability that the vehicle in the learning color histogram is a normal driving vehicle and a probability that the vehicle in the learning color histogram is a wrong-way driving vehicle, to calculate a classification loss indicating a difference between the learning classification value and the label, and to perform optimization to modify the weights of the classification model so that the classification loss is minimized.

The apparatus may further include a learning unit configured to prepare a learning color histogram of an image containing a normal driving vehicle, to input the learning color histogram into an anomaly detection model whose learning is uncompleted, when the anomaly detection model performs a plurality of operations for applying untrained inter-layer weights to the learning color histogram to generate a simulated color histogram that simulates the learning color histogram, to calculate a restoration loss indicating a difference between the learning color histogram and the simulated color histogram, and to perform optimization to modify the weights of the anomaly detection model so that the restoration loss is minimized.

In the apparatus, the learning unit may calculate a threshold value according to Equation θ=μ+(k×σ), wherein μ denotes an average of the mean squared error between a plurality of test color histograms and a plurality of simulated color histograms corresponding to the plurality of test color histograms, σ denotes a standard deviation of the mean squared error between a plurality of test color histograms and a plurality of simulated color histograms corresponding to the plurality of test color histograms, and k denotes a weight for the standard deviation.

The apparatus may further include a learning unit configured to prepare learning data including a learning image and a label, the learning image containing a vehicle object, and the label including a ground-truth box indicating an area occupied by the vehicle object in the learning image and a class vector indicating that a class of the object is a vehicle, to input the learning image into an object detection model whose learning is uncompleted, when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs, to calculate a composite loss including a difference between the bounding box and the ground-truth box and a difference between the class vector and the predictive vector, and to perform optimization to modify the weights of the object detection model so that the composite loss is minimized.

According to the present disclosure, it is possible to detect and track a wrong-way driving vehicle in real time, thereby preventing accidents caused by the wrong-way driving vehicle in advance. In addition, the present disclosure can detect a wrong-way driving vehicle through color histogram analysis, thereby enabling analysis in a single frame only and improving the detection rate of wrong-way driving through the red distribution that appears in vehicle's tail lights at night when image discrimination is difficult.

### DESCRIPTION OF DRAWINGS

FIG. 1 is a schematic diagram illustrating a system for detecting a wrong-way driving vehicle based on image analysis according to the first embodiment of the present disclosure.

FIG. 2 is a block diagram illustrating a traffic server for detecting a wrong-way driving vehicle according to the first embodiment of the present disclosure.

FIG. 3 is a flowchart illustrating a method for generating an object detection model according to the first embodiment of the present disclosure.

FIG. 4 is a diagram illustrating learning data of an object detection model according to the first embodiment of the present disclosure.

FIG. 5 is a diagram illustrating detection values of an object detection model according to the first embodiment of the present disclosure.

FIG. 6 is a flowchart illustrating a method for generating a classification model according to the first embodiment of the present disclosure.

FIG. 7 is a flowchart illustrating a method for generating an anomaly detection model according to the first embodiment of the present disclosure.

FIG. 8 is a flowchart illustrating a method for detecting a wrong-way driving vehicle based on image analysis according to the first embodiment of the present disclosure.

FIG. 9 is a block diagram of a hardware system for implementing an apparatus for detecting a wrong-way driving vehicle based on image analysis according to the first embodiment of the present disclosure.

FIG. 10 is a diagram illustrating a plurality of sensor devices of a system for tracking a wrong-way driving vehicle based on image analysis according to the second embodiment of the present disclosure.

FIG. 11 is a block diagram illustrating a traffic server for tracking a wrong-way driving vehicle according to the second embodiment of the present disclosure.

FIG. 12 is a flowchart illustrating a method for tracking a wrong-way driving vehicle based on image analysis according to the second embodiment of the present disclosure.

FIG. 13 is a block diagram illustrating a traffic server for detecting a wrong-way driving vehicle according to the third embodiment of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### First Embodiment

Hereinafter, the first embodiment related to the detection of a wrong-way driving vehicle will be described with reference to the drawings.

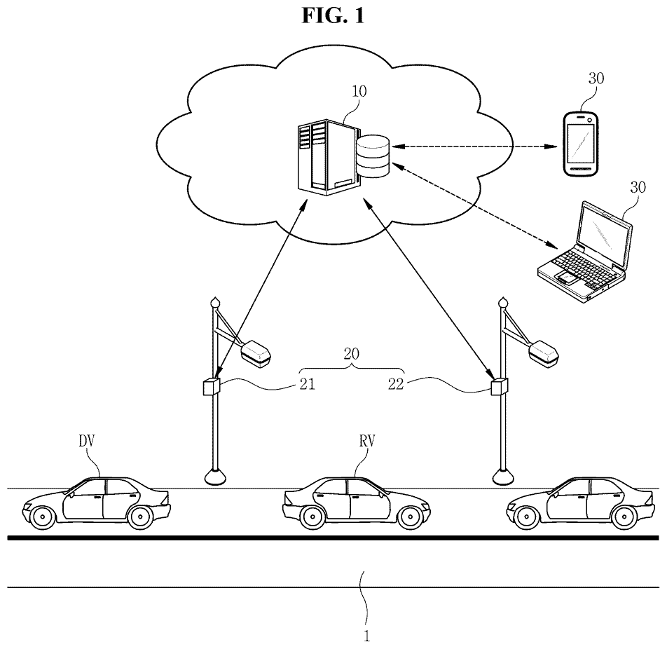

FIG. 1 is a schematic diagram illustrating a system for detecting a wrong-way driving vehicle based on image analysis according to the first embodiment of the present disclosure. Referring to FIG. 1, the system according to the first embodiment of the present disclosure includes a traffic server 10, a plurality of sensor devices 21 and 22 (collectively referred to as 20) managed by the traffic server 10, and a manager device 30.

The traffic server 10 is an apparatus for collecting images of vehicles DV and RV driving on a road 1 from the sensor devices 20 installed at the edge of the road 1 and analyzing the collected images to detect and/or track a wrong-way driving vehicle RV from among the vehicles. Here, the collected images are captured only in lanes in the same direction. For example, in the case of a four-lane road, the images are captured only in two lanes in the same direction. The traffic server 10 uses a learning model (LM) such as a machine learning model or a deep learning model. The learning model (LM) may include an object detection model (DM), a classification model (CM), and an anomaly detection model (ADM).

The sensor devices 20 are installed at the edge of the road 1 and may be arranged at a predetermined interval along the edge. In addition, the sensor devices 20 may be arranged in a zigzag shape at both edges of the road 1 or in a row at one edge. The sensor device 20 may include a camera for capturing images, a transceiver for transmitting the captured images to the traffic server 10, and a microcontroller unit (MCU) for controlling the camera and transceiver. The sensor device 20 may be an Internet of things (IoT) device. The sensor device 20 can access the traffic server 10 through a network and transmit images to the traffic server 10. In particular, the plurality of sensor devices 20 may form a sensor network. In this case, each of the sensor devices 20 can transmit the captured image to a specific one of the sensor devices 20, and the specific sensor device 20 can transmit the plurality of images to the traffic server 10.

The manager device 30 is an electronic device used by a manager who is responsible for managing the traffic server 10 and the sensor devices 20. The manager device 30 may be a smart phone, a tablet, a phablet, a laptop, a personal computer, or the like. In response to manager's manipulation, the manager device 30 can access the traffic server 10 and perform necessary settings or receive information provided by the traffic server 10.

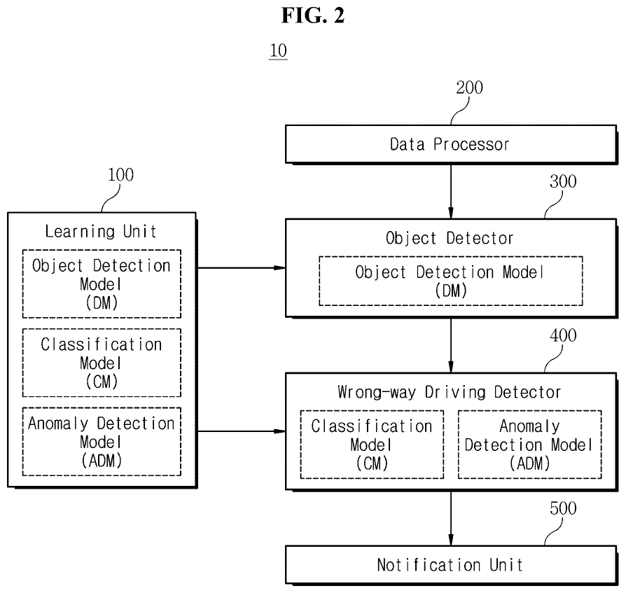

Next, the traffic server 10 according to the first embodiment of the present disclosure will be described in more detail. FIG. 2 is a block diagram illustrating a traffic server for detecting a wrong-way driving vehicle according to the first embodiment of the present disclosure. Referring to FIG. 2, the traffic server 10 includes a learning unit 100, a data processor 200, an object detector 300, a wrong-way driving detector 400, and a notification unit 500.

The learning unit 100 is capable of generating an object detection model (DM), a classification model (CM), and an anomaly detection model (ADM) through learning (machine learning or deep learning). The object detection model (DM) is trained to, when an image is input, derive a detection value obtained by detecting a bounding box indicating an area occupied by an object (i.e., a vehicle) in the input image. The classification model (CM) is trained to, when an image containing a vehicle is input, derive a classification value obtained by identifying whether the vehicle in the input image is a normal driving vehicle or a wrong-way driving vehicle. The anomaly detection model (ADM) is trained to, when an image containing a normal driving vehicle is input, derive a simulated image obtained by simulating the image.

When the object detection model (DM), the classification model (CM), and the anomaly detection model (ADM) are generated, the learning unit 100 provides the object detection model (DM) to the object detector 300 and provides the classification model (CM) and the anomaly detection model (ADM) to the wrong-way driving detector 400. The learning model (LM) including the object detection model (DM), the classification model (CM), and the anomaly detection model (ADM) includes a plurality of layers, and each of the plurality of layers performs a plurality of operations. In one layer, each result of the plurality of operations is weighted and transmitted to the next layer. This means that weights are applied to the operation results of the current layer and input to the operations of the next layer. In other words, the object detection model (DM), the classification model (CM), and the anomaly detection model (ADM) perform a plurality of operations to which the weights of the plurality of layers are applied. The plurality of layers of the object detection model (DM), classification model (CM), and anomaly detection model (ADM) may include at least one of a fully-connected layer, a convolutional layer, a recurrent layer, a graph layer, and a pooling layer. The plurality of operations may include at least one of a convolution operation, a down sampling operation, an up sampling operation, a pooling operation, and an operation by an activation function. Here, the activation function may include a sigmoid, a hyperbolic tangent (tanh), an exponential linear unit (ELU), a rectified linear unit (ReLU), a leakly ReLU, a Maxout, a Minout, or a Softmax.

The object detection model (DM) may be, for example, R-CNN, R-FCN, FPN-FPCN, YOLO, SDD, RetinaNet, etc. When an image is input, the object detection model (DM) performs a plurality of operations for applying weights of a plurality of layers to the input image, and derives a detection value obtained by detecting a bounding box indicating an area occupied by an object, i.e., a vehicle. The classification model (CM) may be, for example, a CNN. When an image containing a vehicle is input, the classification model (CM) performs a plurality of operations for applying weights of a plurality of layers to the input image, and derives a classification value obtained by identifying whether the vehicle in the input image is a normal driving vehicle or a wrong-way driving vehicle. The anomaly detection model (ADM) may be, for example, an auto-encoder (AE). The anomaly detection model (ADM) includes an encoder (EN) and a decoder (DE). The anomaly detection model (ADM) including the encoder and the decoder has a plurality of layers, each of which has a plurality of operations. The plurality of layers are connected with weights. The operation results of one layer are weighted and become the inputs of the next layer. That is, one layer receives weighted values as inputs from the previous layer, performs operations on the received inputs, and transmits the operation results as inputs of the next layer. The encoder includes a plurality of convolution layers (CLs) having a convolution operation and an operation by an activation function. In addition, a pooling layer (PL) performing a max pooling operation may be applied between the convolution layers of the encoder. When an image is input, the encoder performs a plurality of operations for applying inter-layer weights to the input image to compress (encode) the input image and calculate a latent vector. The decoder includes a deconvolution layer (DL) having a deconvolution operation and an operation by an activation function. Each decoder receives the latent vector as an input and performs a plurality of operations for applying inter-layer weights to the input latent value, thereby restoring (decoding) the latent vector and deriving a simulated image that simulates the input image.

The data processor 200 can receive images from the sensor devices 20. Then, the data processor 200 provides the received images to the object detector 300. The images received by the data processor 200 are vehicle images. In addition, the data processor 200 can receive audio signals from the sensor devices 20.

The object detector 300 extracts a bounding box image, which is an image for an area occupied by a vehicle in the image received from the data processor 200, using the object detection model (DM) learned. To this end, the object detector 300 inputs the image received from the data processor 200 into the object detection model (DM). Then, the object detection model (DM) performs a plurality of operations for applying learned inter-layer weights to the input image and thus detect a bounding box (BB) indicating an area occupied by a vehicle in the image. Accordingly, the object detector 300 can derive a bounding box image for the area occupied by the vehicle in the input image.

The wrong-way driving detector 400 detects a wrong-way driving vehicle by using at least one of the learned classification model (CM) and the learned anomaly detection model (ADM). The wrong-way driving detector 400 inputs the bounding box image into the classification model (CM). Then, the classification model (CM) performs a plurality of operations for applying learned inter-layer weights to the bounding box image and thus calculates a classification value indicating a probability that a vehicle in the bounding box image is a normal driving vehicle and a probability that the vehicle in the bounding box image is a wrong-way driving vehicle. Then, based on the classification value, the wrong-way driving detector 400 derives a first determination result indicating whether the vehicle is a wrong-way driving vehicle. Additionally, the wrong-way driving detector 400 inputs the bounding box image into the anomaly detection model (ADM). Then, the anomaly detection model (ADM) performs a plurality of operations for applying learned inter-layer weights to the bounding box image and thus derives a simulated image obtained by simulating the bounding box image. Then, the wrong-way driving detector 400 calculates a restoration loss indicating a difference between the bounding box image and the simulated image and, based on whether the calculated restoration loss is less than a predetermined threshold, derives a second determination result indicating whether the vehicle is a wrong-way driving vehicle. By considering both the first determination result by the classification model (CM) and the second determination result by the anomaly detection model (ADM), the wrong-way driving detector 400 can determine whether the vehicle in the bounding box image is a wrong-way driving vehicle.

The notification unit 500 can provide the manager device 30 with information on whether the vehicle is wrong-way driving. It is therefore possible to detect a wrong-way driving vehicle in real time and quickly cope with the risk of wrong-way driving. At this time, the notification unit 500 may transmit a warning about the wrong-way driving vehicle to the vehicle's trip computer or navigation device through the network.

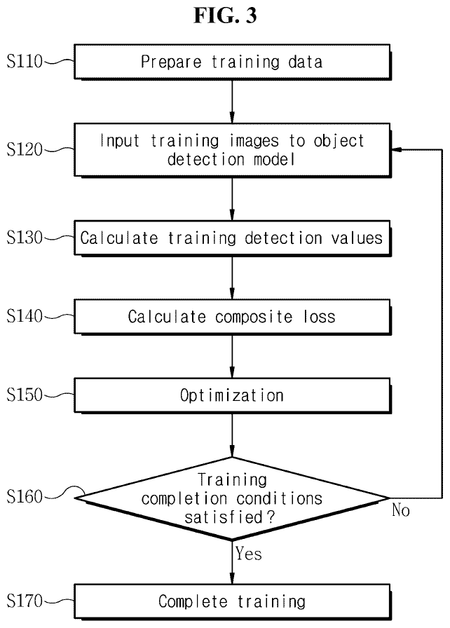

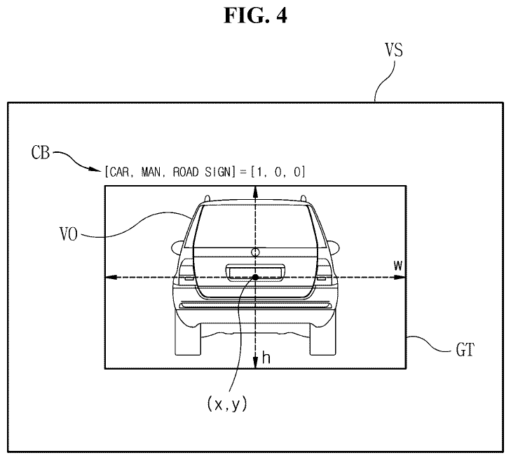

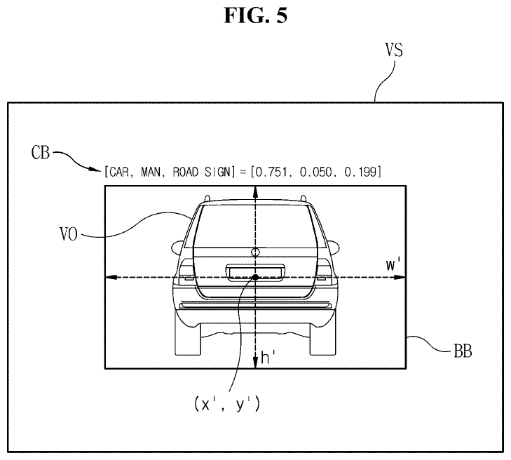

Next, the generation of the object detection model (DM) according to the first embodiment of the present disclosure will be described. FIG. 3 is a flowchart illustrating a method for generating an object detection model according to the first embodiment of the present disclosure. FIG. 4 is a diagram illustrating learning data of an object detection model according to the first embodiment of the present disclosure. FIG. 5 is a diagram illustrating detection values of an object detection model according to the first embodiment of the present disclosure.

Referring to FIG. 3, in step S110, the learning unit 100 prepares learning data (or referred to as training data herein) for training the object detection model (DM). The learning data includes a learning image (or referred to as a training image herein) and a label corresponding to the learning image. As illustrated in FIG. 4, the learning image is a vehicle scene (VS). That is, the learning image contains a vehicle object (VO). The label includes a ground-truth box (GT) and a class vector indicating that the class of the object is a vehicle. The ground-truth box (GT) indicates an area occupied by the vehicle object (VO) contained in the learning image. As illustrated in FIG. 4, the ground-truth box (GT) has center coordinates (x, y), width (w), and height (h). The class vector (CB) represents a class (i.e., “car” class) to which the vehicle object (VO) in the ground-truth box (GT) belongs. For example, assume that the class vector (CB) is in the form of a one-hot-encoding vector and that there are only three classes of objects, including car, man, and load sign. In this case, the class vector (CB) corresponding to the vehicle object in the ground-truth box (GT) may be [CAR, MAN, ROAD SIGN]=[1, 0, 0].

When the learning data is prepared, in step S120, the learning unit 100 inputs the learning image into the object detection model (DM) whose learning is uncompleted. Then, in step S130, the object detection model (DM) performs a plurality of operations for applying untrained inter-layer weights to the learning image and thus calculates a learning detection value (or referred to as a training detection value herein) that includes a bounding box (BB) and a class vector corresponding to the bounding box (BB). The bounding box (BB) indicates an area occupied by an object (i.e., a vehicle) detected in the learning image, and the class vector is a predicted value that is a probability predicting the class to which the detected object (VO) in the bounding box (BB) belongs. For example, the learning detection value may be “BB=(x′, y′, w′, h′), [CAR, MAN, ROAD SIGN]=[0.751, 0.050, 0.199]” as illustrated in FIG. 5.

Then, in step S140, the learning unit 100 calculates a composite loss indicating a difference between the learning detection value and the label through a loss function. Here, the composite loss includes a difference between the bounding box (BB) of the learning detection value and the ground-truth box (GT) of the label and a difference between the class vector corresponding to the bounding box (BB) and a predictive vector corresponding to the ground-truth box (GT).

Subsequently, in step S150, the learning unit 100 performs optimization to modify the weights of the object detection model (DM) so that the composite loss derived through the loss function is minimized.

The above-described steps S120 to S150 are repeatedly performed using a plurality of different learning data, and the weights of the object detection model (DM) are repeatedly updated according to this repetition. In addition, this repetition is performed until the composite loss converges and becomes lower than a predetermined target value. Therefore, in step S160, the learning unit 100 determines whether the composite loss calculated previously in the step S140 converges and becomes lower than the predetermined target value. If the composite loss is lower than the predetermined target value, that is, if the learning completion condition is met, the learning for the object detection model (DM) is completed in step S170.

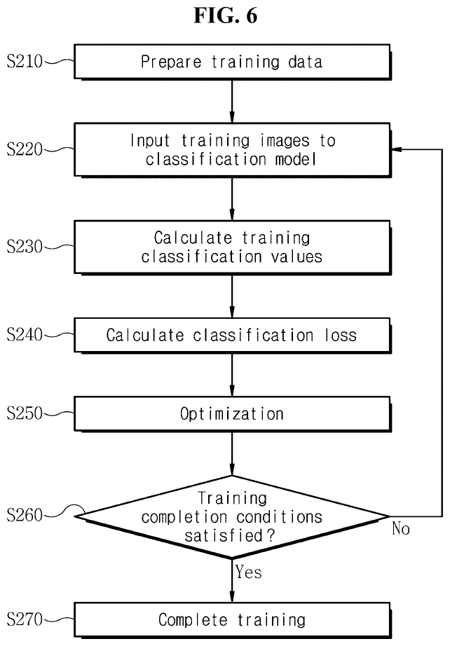

Next, the generation of the classification model (CM) according to the first embodiment of the present disclosure will be described. FIG. 6 is a flowchart illustrating a method for generating a classification model according to the first embodiment of the present disclosure.

Referring to FIG. 6, in step S210, the learning unit 100 prepares learning data (or referred to as training data herein) for training the classification model (CM). The learning data includes a learning image (or referred to as a training image herein) and a label corresponding to the learning image. The learning image includes an image that contains a normal driving vehicle or a wrong-way driving vehicle. In particular, the learning image may be an image within the bounding box (BB) detected by the object detection model (DM). In addition, the label may be a distinguishing vector that distinguishes whether a vehicle in the learning image is a normal driving vehicle or a wrong-way driving vehicle. The distinguishing vector may be in the form of a one-hot-encoding vector. For example, the distinguishing vector may be [normal driving, wrong-way driving]=[1, 0] in the case of a normal driving vehicle, and [normal driving, wrong-way driving]=[0, 1] in the case of a wrong-way driving vehicle.

When the learning data is prepared, in step S220, the learning unit 100 inputs the learning image into the classification model (CM) whose learning is uncompleted. Then, in step S230, the classification model (CM) performs a plurality of operations for applying untrained inter-layer weights to the learning image, thereby calculating a learning classification value (or referred to as a training classification value herein). For example, the learning classification value may be [normal driving, wrong-way driving]=[0.70, 0.30].

Then, in step S240, the learning unit 100 calculates a classification loss indicating a difference between the learning classification value and the label through a loss function. Subsequently, in step S250, the learning unit 100 performs optimization to modify the weights of the classification model (CM) so that the classification loss derived through the loss function is minimized.

The above-described steps S220 to S250 are repeatedly performed using a plurality of different learning data, and the weights of the classification model (CM) are repeatedly updated according to this repetition. In addition, this repetition is performed until the classification loss converges and becomes lower than a predetermined target value. Therefore, in step S260, the learning unit 100 determines whether the classification loss calculated previously in the step S240 is lower than the predetermined target value. If the classification loss is lower than the predetermined target value, that is, if the learning completion condition is met, the learning for the classification model (CM) is completed in step S270.

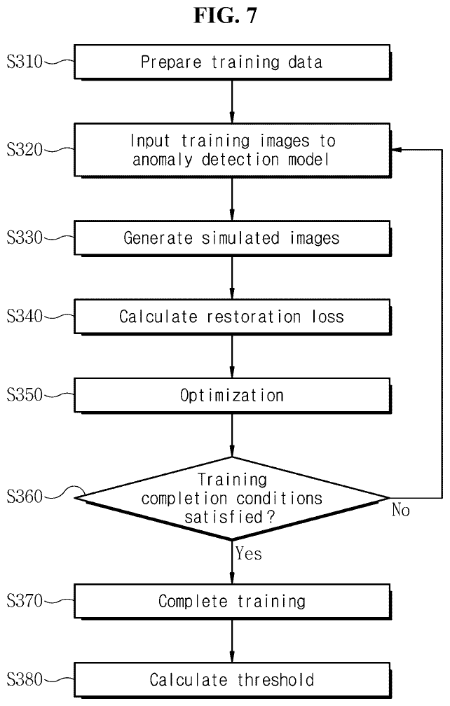

Next, the generation of the anomaly detection model (ADM) according to the first embodiment of the present disclosure will be described. FIG. 7 is a flowchart illustrating a method for generating an anomaly detection model according to the first embodiment of the present disclosure.

Referring to FIG. 7, in step S310, the learning unit 100 prepares learning data (or referred to as training data herein) for the anomaly detection model (ADM). Here, the learning data includes a learning image (or referred to as a training image herein). The learning image includes an image containing a normal driving vehicle.

In step S320, the learning unit 100 inputs the learning image into the anomaly detection model (ADM) whose learning is uncompleted. Then, in step S330, the anomaly detection model (ADM) compresses and restores the learning image through a plurality of operations for applying inter-layer weights to the learning image, thereby deriving a simulated image that simulates the learning image.

Specifically, the encoder of the anomaly detection model (ADM) compresses the learning image by performing a plurality of operations for applying inter-layer weights to the learning image, thereby calculating a latent vector. In addition, the decoder of the anomaly detection model (ADM) restores the latent vector by performing a plurality of operations for applying inter-layer weights to the latent vector calculated by the encoder, thereby calculating the simulated image.

Then, in step S340, the learning unit 100 calculates a restoration loss indicating a difference between the learning image and the simulated image through a loss function.

At this time, the learning unit 100 may calculate the restoration loss according to Equation 1 below.

$$L = \frac{1}{m} {\sum }_{j = 1}^{m} g ( X ( j ) , Y ( j ) ) \qquad [ Equation 1 ]$$

In Equation 1, X denotes a learning image, and Y denotes a simulated image. In addition, g denotes a loss function, m denotes the number of learning data, i.e., the number of learning images, and j is the index of the learning data, i.e., the index of the learning image.

In addition, the loss function in Equation 1 may be Equation 2 below.

$$g ( X , Y ) = {‖ X - Y ‖}_{2} \qquad [ Equation 2 ]$$

Here, X denotes a learning image, and Y denotes a simulated image. As can be seen from Equations 1 and 2, the restoration loss indicates a difference between the learning image and the simulated image.

Then, in step S350, the learning unit 100 performs optimization to update the weights of the anomaly detection model (ADM) through a backpropagation algorithm so that the loss is minimized.

Next, in step S360, the learning unit 100 determines whether a condition necessary for learning completion is satisfied. Here, the learning completion condition (or referred to as the training completion condition herein) may be whether the restoration loss calculated previously in the step S340 is less than a predetermined target value. If it is determined in the step S360 that the learning completion condition is not satisfied, that is, if the restoration loss calculated previously in the step S340 is greater than or equal to the target value, the process proceeds to the step S320 and repeats the steps S320 to S360 described above. This means that learning is repeated using a plurality of different learning images. On the other hand, if it is determined in the step S360 that the learning completion condition is satisfied, that is, if the restoration loss calculated previously in the step S340 is less than the target value, the process proceeds to step S370 and completes learning.

When learning is completed, the learning unit 100 derives a threshold value of the anomaly detection model (ADM) in step S380. Specifically, the learning unit 100 prepares test data. The test data includes a plurality of test images. The test images are prepared in the same manner as the learning images. That is, like the learning image, the test image includes an image of a normal driving vehicle. Then, the learning unit 100 inputs the plurality of test images into the anomaly detection model (ADM) whose learning is completed. Then, the anomaly detection model (ADM) generates a plurality of simulated images corresponding to the plurality of test images. Then, the learning unit 100 calculates a threshold value of the anomaly detection model (ADM) through Equation 3 below.

$$θ = μ + ( k \times σ ) \qquad [ Equation 3 ]$$

In Equation 3, θ denotes a threshold value. Here, μ denotes an average of the mean squared error (MSE) between a plurality of test images and a plurality of simulated images corresponding to the plurality of test images. Also, σ denotes a standard deviation of the mean squared error between a plurality of test images and a plurality of simulated images corresponding to the plurality of test images. In addition, k denotes a weight for the standard deviation, and it is a value that is set in advance. The learning unit 100 provides the learning-completed anomaly detection model (ADM) and the threshold value of the anomaly detection model (ADM) to the wrong-way driving detector 400.

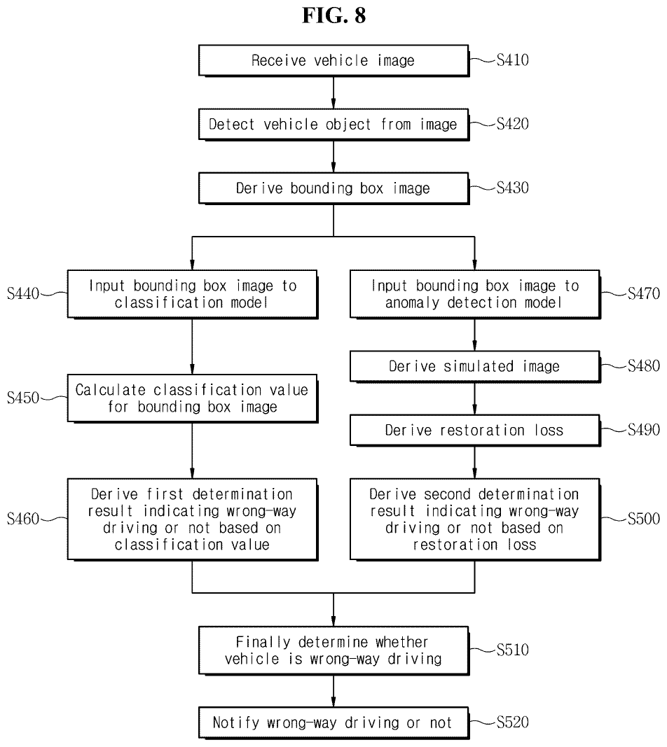

Next, a method for detecting a wrong-way driving vehicle based on object image analysis according to the first embodiment of the present disclosure will be described. FIG. 8 is a flowchart illustrating a method for detecting a wrong-way driving vehicle based on image analysis according to the first embodiment of the present disclosure.

Referring to FIG. 8, in step S410, the data processor 200 receives an image of a vehicle from the sensor device 20.

Next, in step S420, the object detector 300 detects a vehicle object from the received image by using the object detection model (DM) learned. That is, the object detector 300 inputs the image received from the data processor 200 into the object detection model (DM). Then, the object detection model (DM) performs a plurality of operations for applying a plurality of learned inter-layer weights to the input image to calculate a detection value. This detection value includes the vehicle object detected in the input image.

Next, in step S430, the object detector 300 derives an image of a bounding box (BB) from the input image. The bounding box (BB) indicates an area occupied by the vehicle object in the input image. For example, referring to FIG. 5, the image of the bounding box (BB) is extracted from the image (VS) of FIG. 5.

Next, in step S440, the wrong-way driving detector 400 inputs the bounding box image into the classification model (DM). Then, in step S450, the classification model (DM) performs a plurality of operations for applying learned inter-layer weights to the bounding box image, thereby calculating a classification value. The classification value includes a probability that the vehicle object in the bounding box image is a normal driving vehicle and a probability that the vehicle object in the bounding box image is a wrong-way driving vehicle. The classification value may be [normal driving, wrong-way driving]=[0.70, 0.30]. This indicates that the vehicle object in the bounding box image has a 70% probability of being a normal driving vehicle and a 30% probability of being a wrong-way driving vehicle. Alternatively, the classification value may be [normal driving, wrong-way driving]=[0.20, 0.80]. This indicates that the vehicle object in the bounding box image has a 20% probability of being a normal driving vehicle and an 80% probability of being a wrong-way driving vehicle.

In step S460, based on the classification value, the wrong-way driving detector 400 derives a first determination result indicating whether the vehicle is wrong-way driving. That is, the wrong-way driving detector 400 derives the first determination result based on the probability of a normal driving vehicle and the probability of a wrong-way driving vehicle in the classification value. For example, if the classification value is [normal driving, wrong-way driving]=[0.70, 0.30], the vehicle in the bounding box image may be determined to be a normal driving vehicle because the probability of a normal driving vehicle is 70% and the probability of a wrong-way driving vehicle is 30%. On the other hand, if the classification value is [normal driving, wrong-way driving]=[0.20, 0.80], the vehicle in the bounding box image maybe determined to be a wrong-way driving vehicle because the probability of a normal driving vehicle is 20% and the probability of a wrong-way driving vehicle is 80%.

Meanwhile, in step S470, the wrong-way driving detector 400 inputs the bounding box image into the anomaly detection model (ADM). Then, in step S480, the anomaly detection model (ADM) performs a plurality of operations for applying learned inter-layer weights to the bounding box image, thereby compressing and then restoring the bounding box image to derive a simulated image that simulates the bounding box image. For example, the encoder of the anomaly detection model (ADM) performs a plurality of operations for applying learned inter-layer weights to the bounding box image to compress the bounding box image and derive a latent vector, and the decoder of the anomaly detection model (ADM) performs a plurality of operations for applying learned inter-layer weights to the latent vector derived by the encoder to restore the latent vector and derive the simulated image.

Next, in step S490, the wrong-way driving detector 400 calculates a restoration loss through a loss function. Here, the restoration loss indicates a difference between the bounding box image and the simulated image.

When the restoration loss is calculated, in step S500, the wrong-way driving detector 400 compares the restoration loss with a threshold and thereby derives a second determination result indicating whether the vehicle is wrong-way driving. That is, the wrong-way driving detector 400 checks whether the restoration loss is less than the threshold value (in Equation 3), and if the restoration loss is less than the threshold value, the wrong-way driving detector 400 determines that the vehicle in the bounding box image is a normal driving vehicle. On the other hand, if the restoration loss is greater than or equal to the threshold value, the wrong-way driving detector 400 determines that the vehicle in the bounding box image is a wrong-way driving vehicle.

Next, in step S510, the wrong-way driving detector 400 may determine whether the vehicle in the bounding box image is wrong-way driving, by considering both the first determination result by the classification model (CM) and the second determination result by the anomaly detection model (ADM). In one example, if both the first determination result by the classification model (CM) and the second determination result by the anomaly detection model (ADM) indicate the wrong-way driving vehicle, the wrong-way driving detector 400 may finally determine the vehicle to be wrong-way driving. In another example, if either of the first determination result by the classification model (CM) and the second determination result by the anomaly detection model (ADM) indicate the wrong-way driving vehicle, the wrong-way driving detector 400 may finally determine the vehicle to be wrong-way driving.

Next, in step S520, the notification unit 500 may provide the manager device 30 with information on whether the vehicle is wrong-way driving. Accordingly, it is possible to detect a wrong-way driving vehicle in real time and quickly cope with the risk of wrong-way driving.

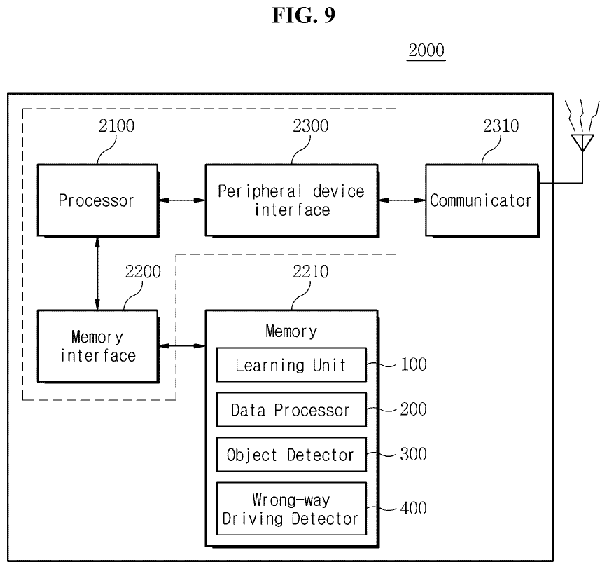

FIG. 9 is a block diagram of a hardware system for implementing an apparatus for detecting a wrong-way driving vehicle based on image analysis according to the first embodiment of the present disclosure.

As shown in FIG. 9, the hardware system 2000 according to the first embodiment of the present disclosure may include a processor 2100, a memory interface 2200, and a peripheral device interface 2300.

These respective elements in the hardware system 2000 may be individual components or be integrated into one or more integrated circuits and may be connected by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, the learning unit 100, the data processor 200, the object detector 300, the wrong-way driving detector 400, and the notification unit 500, which are described above with reference to FIG. 2, may be stored in the form of software modules, and the operating system (OS) may be further stored. Each of the learning unit 100, the data processor 200, the object detector 300, the wrong-way driving detector 400, and the notification unit 500 may be loaded and executed by the processor 2100.

Each of the learning unit 100, the data processor 200, the object detector 300, the wrong-way driving detector 400, and the notification unit 500 may be implemented in the form of a software module or hardware module executed by the processor 2100, or may also be implemented in the form of a combination of a software module and a hardware module.

As such, the software module, the hardware module, or the combination thereof executed by the processor may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices.

The peripheral devices are to provide different functions to the hardware system 2000, and may include a communicator 2310 for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to the first embodiment of the present disclosure, each element stored in the memory 2210 in the form of a software module performs an interface with the communicator 2310 via the memory interface 2200 and the peripheral device interface 2300 in the form of a command executed by the processor 2100.

### Second Embodiment

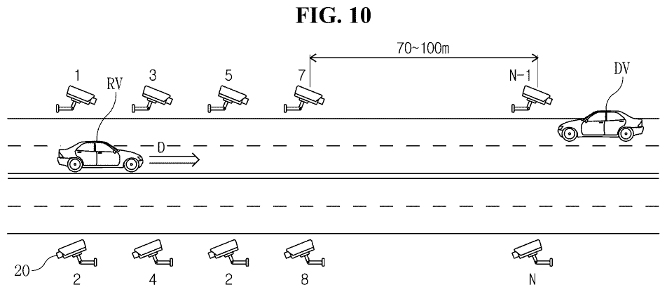

Hereinafter, the second embodiment of the present disclosure will be described with reference to the drawings. The second embodiment of the present disclosure relates to tracking of a wrong-way vehicle based on image analysis. A system for tracking a wrong-way vehicle based on image analysis according to the second embodiment of the present disclosure is the same as the above-described system of the first embodiment illustrated in FIG. 1. Meanwhile, FIG. 10 is a diagram illustrating a plurality of sensor devices of a system for tracking a wrong-way driving vehicle based on image analysis according to the second embodiment of the present disclosure. The same contents as described in the first embodiment with reference to FIG. 1 will be omitted below.

Referring to FIGS. 1 and 10, the system according to the second embodiment of the present disclosure includes the traffic server 10, the plurality of sensor devices 20 managed by the traffic server 10, and the manager device 30.

The plurality of sensor devices 20 include a first sensor device 21 and a plurality of second sensor devices 22. In FIG. 10, reference numerals 1 to N denote the positions and orders of the plurality of sensor devices 20 arranged sequentially. According to an example, it is assumed that the first sensor device 21 is a sensor device arranged at position 1, and the plurality of second sensor devices 22 are sensor devices 20 arranged at positions 2 to N. In order to track a wrong-way vehicle (also referred to as a reverse vehicle (RV)), each of the sensor devices 20 transmits a captured image to the traffic server 10 in response to a request from the traffic server 10.

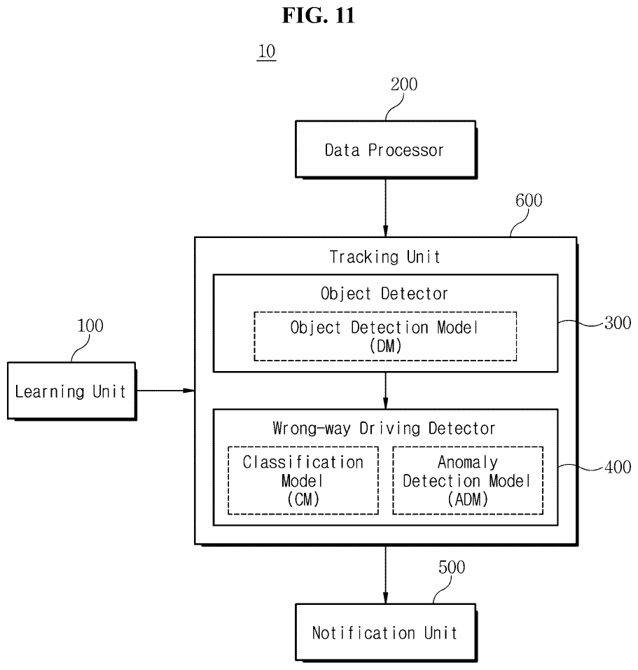

FIG. 11 is a block diagram illustrating a traffic server for tracking a wrong-way driving vehicle according to the second embodiment of the present disclosure. The traffic server according to the second embodiment illustrated in FIG. 11 is similar to the traffic server according to the first embodiment illustrated in FIG. 2, and only differences therebetween will be described below.

Referring to FIG. 11, the traffic server 10 includes the learning unit 100, the data processor 200, a tracking unit 600, and the notification unit 500.

The images transmitted respectively by the sensor devices 20 are received by the data processor 200 and transferred to the object detector 300 of the tracking unit 600. This image is an image of a vehicle. The data processor 200 receives the vehicle image from the first sensor device 21, and when a wrong-way driving vehicle is detected in the received image, it may receive images from the plurality of second sensor devices 22 at the request of the tracking unit 600.

The tracking unit 600 analyzes the image received from the first sensor device 21 through one or more learning models, i.e., the object detection model (DM), the classification model (CM), and the anomaly detection model (ADM), to determine whether a wrong-way driving vehicle is detected in the received image. If a wrong-way driving vehicle is detected in the image received from the first sensor device 21, the tracking unit 600 receives images captured by the second sensor devices 22 through the data processor 200 to continuously detect the wrong-way driving vehicle, thereby tracking the wrong-way driving vehicle. At this time, the tracking unit 600 receives the images from one or more second sensor devices 22 in the order of proximity to the first sensor device 21 among the plurality of second sensor devices 22 arranged in the direction of travel of the detected wrong-way driving vehicle. In addition, the tracking unit 600 analyzes the images received from one or more second sensor devices 22 through one or more learning models and detects a wrong-way driving vehicle in the analyzed images, thereby tracking the wrong-way driving vehicle.

As shown in FIG. 11, the tracking unit 600 includes the object detector 300 and the wrong-way driving detector 400. The object detector 300 and the wrong-way driving detector 400 are the same as in the first embodiment described above.

However, upon detecting a wrong-way driving vehicle, the wrong-way driving detector 400 generates tracking information including an image in which the wrong-way driving vehicle is detected, identification information and location information of the sensor device 20 that is a source of the image, and coordinates and detection time of the bounding box of the wrong-way driving vehicle detected in the image.

The notification unit 500 can provide the manager device 30 with the tracking information. It is therefore possible to detect and track a wrong-way driving vehicle in real time and quickly cope with the risk of wrong-way driving.

Meanwhile, a method for generating the object detection model (DM) according to the second embodiment of the present disclosure is the same as the method in the first embodiment described above with reference to FIGS. 3 to 5. Therefore, the related description is omitted.

In addition, the method for generating the classification model (CM) according to the second embodiment of the present disclosure is the same as the method in the first embodiment described above with reference to FIG. 6. Therefore, the related description is omitted.

In addition, the method for generating the anomaly detection model (ADM) according to the second embodiment of the present disclosure is the same as the method in the first embodiment described above with reference to FIG. 7. Therefore, the related description is omitted.

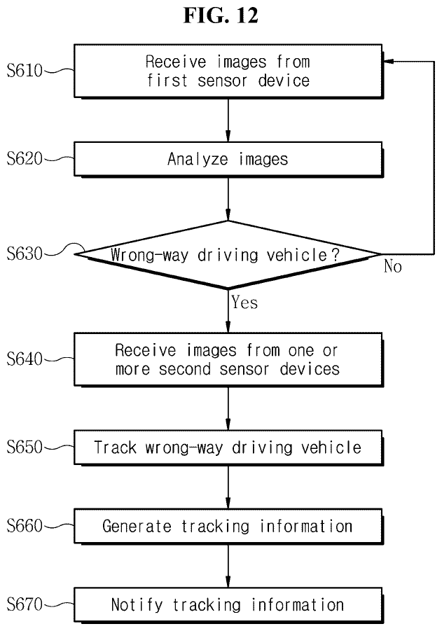

Next, a method for tracking a wrong-way driving vehicle based on image analysis according to the second embodiment of the present disclosure will be described. FIG. 12 is a flowchart illustrating a method for tracking a wrong-way driving vehicle based on image analysis according to the second embodiment of the present disclosure.

The second embodiment of FIG. 12 assumes a state in which the plurality of sensor devices 20 are arranged at a predetermined interval along the road 1. Also, it is assumed that the plurality of sensor devices 20 include the first sensor device 21 and the plurality of second sensor devices 22 as shown in FIG. 1, reference numbers 1 to N in FIG. 10 indicate the positions and orders of the plurality of sensor devices 20 arranged sequentially, the first sensor device 21 is a sensor device arranged at position 1, and the plurality of second sensor devices 22 are sensor devices 20 arranged at positions 2 to N.

Referring to FIG. 12, in step S610, the data processor 200 receives an image from the first sensor device 21 among the plurality of sensor devices 20 and transmits the received image to the tracking unit 600.

Then, the tracking unit 600 analyzes the received image through at least one learning model in step S620 and determines in step S630 whether a wrong-way driving vehicle exists in the received image.

If it is determined in the step S630 that there is no wrong-way driving vehicle in the image, the above-described steps S610 to S630 are repeated. On the other hand, if it is determined in the step S630 that there is a wrong-way driving vehicle in the image, the process proceeds to step S640.

In step S640, the tracking unit 600 collects images from one or more second sensor devices 22. At this time, the tracking unit 600 receives images from one or more second sensor devices 22 in the order of proximity to the first sensor device 21 among the plurality of second sensor devices 22 arranged in the direction of travel of the wrong-way driving vehicle. Referring to FIG. 10, for example, images are received from the second sensor devices 22 at positions 3, 5, and 7 in the order of proximity to the first sensor device 21 among the plurality of second sensor devices 22 arranged in the travel direction (D) of the wrong-way driving vehicle (RV).

Next, in step S650, the tracking unit 600 analyzes the collected images through one or more learning models and continuously detects a wrong-way driving vehicle in the analyzed images, thereby tracking the wrong-way driving vehicle.

In addition, in step S660, the tracking unit 600 generates tracking information including an image in which the wrong-way driving vehicle is detected, identification information and location information of the sensor device 20 that is a source of the image, and coordinates and detection time of the bounding box of the wrong-way driving vehicle detected in the image.

Then, in step S670, the notification unit 500 notifies the generated tracking information to the manager device 30. It is therefore possible to detect and track a wrong-way driving vehicle in real time and quickly cope with the risk of wrong-way driving.

Meanwhile, the method for detecting a wrong-way driving vehicle in the steps S630 and S650 described above is the same as that described with reference to FIG. 8 in the first embodiment. Duplicate description is omitted.

### Third Embodiment

Hereinafter, the third embodiment of the present disclosure will be described. The third embodiment of the present disclosure relates to detecting a wrong-way driving vehicle based on color histogram analysis. A system for detecting a wrong-way driving vehicle based on color histogram analysis according to the third embodiment of the present disclosure is the same as the above-described system of the first embodiment illustrated in FIG. 1. Therefore, the same contents as described in the first embodiment with reference to FIG. 1 will be omitted below.

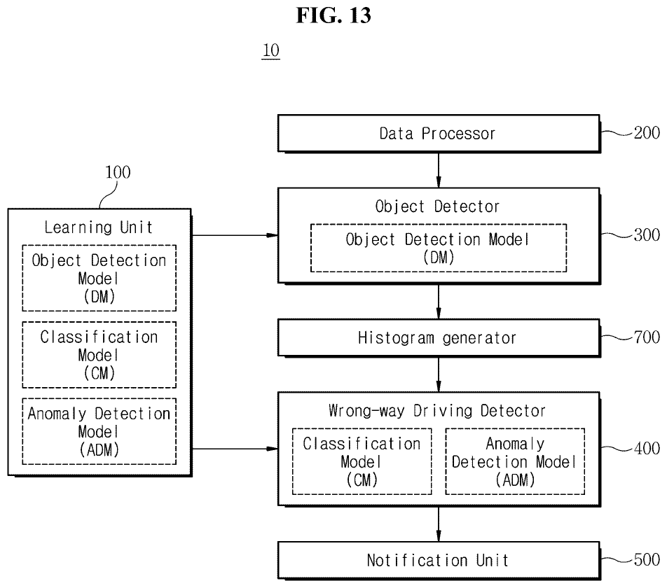

Next, the traffic server 10 for detecting a wrong-way driving vehicle according to the third embodiment of the present disclosure will be described in more detail. FIG. 13 is a block diagram illustrating a traffic server for detecting a wrong-way driving vehicle according to the third embodiment of the present disclosure. Referring to FIG. 13, the traffic server 10 includes the learning unit 100, the data processor 200, the object detector 300, a histogram generator 700, the wrong-way driving detector 400, and the notification unit 500.

The learning unit 100 is capable of generating the object detection model (DM), the classification model (CM), and the anomaly detection model (ADM) through learning (machine learning or deep learning). The object detection model (DM) is trained to, when an image obtained by capturing a vehicle driving on a road is input, derive a detection value obtained by detecting a bounding box indicating an area occupied by an object (i.e., a vehicle) in the input image. The classification model (CM) is trained to, when a color histogram of an image containing a vehicle is input, derive a classification value obtained by identifying whether the vehicle in the input image is a normal driving vehicle or a wrong-way driving vehicle. The anomaly detection model (ADM) is trained to, when a color histogram of an image containing a normal driving vehicle is input, derive a simulated color histogram obtained by simulating the color histogram.

Since the data processor 200 and the object detector 300 are the same as those described above in the first embodiment, their descriptions will be omitted.

The histogram generator 700 is for detecting a color histogram from a bounding box image. The color histogram represents the color distribution of the bounding box image. The color histogram indicates the number of pixels that have colors in a color range list belonging to a color space. For example, when the color space uses RGB, the color histogram represents the number of all pixels that have a color in the RGB color space. The color histogram may be detected using all kinds of color spaces. Preferably, the color histogram may use at least one of RGB, YCBR, LUV, and HSV.

The wrong-way driving detector 400 analyzes the color histogram of the bounding box image detected by the histogram generator 700 and identifies a difference in color distribution between the front and rear of the vehicle, thereby determining whether the vehicle in the bounding box image is a wrong-way driving vehicle. To this end, the wrong-way driving detector 400 detects a wrong-way driving vehicle through analysis of the color histogram by using at least one of the learned classification model (CM) and the learned anomaly detection model (ADM). Specifically, the wrong-way driving detector 400 inputs the color histogram of the bounding box image into the classification model (CM). Then, the classification model (CM) performs a plurality of operations for applying learned inter-layer weights to the color histogram and thus calculates a classification value indicating a probability that a vehicle in the bounding box image, which is the basis of the color histogram, is a normal driving vehicle and a probability that the vehicle in the bounding box image is a wrong-way driving vehicle. Then, based on the classification value, the wrong-way driving detector 400 derives a first determination result indicating whether the vehicle is a wrong-way driving vehicle. Additionally, the wrong-way driving detector 400 inputs the color histogram of the bounding box image into the anomaly detection model (ADM). Then, the anomaly detection model (ADM) performs a plurality of operations for applying learned inter-layer weights to the color histogram and thus derives a simulated color histogram obtained by simulating the color histogram. Then, the wrong-way driving detector 400 calculates a restoration loss indicating a difference between the color histogram and the simulated color histogram and, based on whether the calculated restoration loss is less than a predetermined threshold, derives a second determination result indicating whether the vehicle is a wrong-way driving vehicle. By considering both the first determination result by the classification model (CM) and the second determination result by the anomaly detection model (ADM), the wrong-way driving detector 400 can determine whether the vehicle in the bounding box image is a wrong-way driving vehicle.

Meanwhile, a method for generating the object detection model (DM) according to the third embodiment of the present disclosure is the same as the method in the first embodiment described above with reference to FIGS. 3 to 5. Therefore, the related description is omitted.

In addition, a method for generating the classification model (CM) according to the third embodiment of the present disclosure is similar to the method in the first embodiment described above with reference to FIG. 6. Therefore, the same description is omitted. However, in the case of the third embodiment, the learning data of step S210 in FIG. 6 is different from that of the first embodiment in that it includes a learning color histogram and a label corresponding to the learning color histogram.

The learning color histogram is a color histogram detected from an image that contains a normal driving vehicle or a wrong-way driving vehicle. In particular, the learning color histogram may be a color histogram of the bounding box image detected by the object detection model (DM). In addition, the label may be a distinguishing vector that distinguishes whether a vehicle in the image, which is the basis of the learning color histogram, is a normal driving vehicle or a wrong-way driving vehicle. The distinguishing vector may be in the form of a one-hot-encoding vector. For example, the distinguishing vector may be [normal driving, wrong-way driving]=[1, 0] in the case of a normal driving vehicle, and [normal driving, wrong-way driving]=[0, 1] in the case of a wrong-way driving vehicle.

When the learning data is prepared, in step S220, the learning unit 100 inputs the learning color histogram of the learning data into the classification model (CM) whose learning is uncompleted. Then, in step S230, the classification model (CM) performs a plurality of operations for applying untrained inter-layer weights to the learning color histogram, thereby calculating a learning classification. For example, the learning classification value may be [normal driving, wrong-way driving]=[0.70, 0.30].

Next, a method for generating the anomaly detection model (ADM) according to the third embodiment of the present disclosure is similar to the method in the first embodiment described above with reference to FIG. 7. Therefore, the same description is omitted. However, the learning data of step S310 illustrated in FIG. 7 in the third embodiment is different from the first embodiment in that it includes a learning color histogram. The learning color histogram is a color histogram detected from an image containing a normal driving vehicle.

In step S320, the learning unit 100 inputs the learning color histogram into the anomaly detection model (ADM) whose learning is uncompleted. Then, in step S330, the anomaly detection model (ADM) compresses and restores the learning color histogram through a plurality of operations for applying inter-layer weights to the learning color histogram, thereby deriving a simulated color histogram that simulates the learning color histogram.

Then, in step S340, the learning unit 100 calculates a restoration loss indicating a difference between the learning color histogram and the simulated color histogram through a loss function.

At this time, the learning unit 100 may calculate the restoration loss according to the above-described Equation 1. In addition, the loss function in Equation 1 may be the above-described Equation 2. In Equation 1, X denotes a learning color histogram, and Y denotes a simulated color histogram. In addition, g denotes a loss function, m denotes the number of learning data, i.e., the number of learning color histograms, and j is the index of the learning data, i.e., the index of the learning color histogram.

As can be seen from Equations 1 and 2, the restoration loss indicates a difference between the learning color histogram and the simulated color histogram.

Then, in step S350, the learning unit 100 performs optimization to update the weights of the anomaly detection model (ADM) through a backpropagation algorithm so that the loss is minimized.

Steps S360 and S370 are the same as described above in the first embodiment.

When learning is completed, the learning unit 100 derives a threshold value of the anomaly detection model (ADM) in step S380. Specifically, the learning unit 100 prepares test data. The test data includes a plurality of test color histograms. The test color histograms are prepared in the same manner as the learning color histograms. That is, like the learning color histogram, the test color histogram is a color histogram of an image that contains a normal driving vehicle. Then, the learning unit 100 inputs the plurality of test color histograms into the anomaly detection model (ADM) whose learning is completed. Then, the anomaly detection model (ADM) generates a plurality of simulated color histograms corresponding to the plurality of test color histograms. Then, the learning unit 100 calculates a threshold value of the anomaly detection model (ADM) through Equation 3 described above.

In Equation 3, θ denotes a threshold value. Here, μ denotes an average of the mean squared error (MSE) between a plurality of test color histograms and a plurality of simulated color histograms corresponding to the plurality of test color histograms. Also, σ denotes a standard deviation of the mean squared error between a plurality of test color histograms and a plurality of simulated color histograms corresponding to the plurality of test color histograms. In addition, k denotes a weight for the standard deviation, and it is a value that is set in advance. The learning unit 100 provides the learning-completed anomaly detection model (ADM) and the threshold value of the anomaly detection model (ADM) to the wrong-way driving detector 400.

Next, a method for detecting a wrong-way driving vehicle based on color histogram analysis according to the third embodiment of the present disclosure is similar to the method in the first embodiment described above with reference to FIG. 8. Therefore, the same description is omitted.

However, in the case of the third embodiment, there is a difference from the first embodiment in that, after step S430, the histogram generator 700 performs a step of deriving a color histogram from the bounding box image. The color histogram indicates the color distribution of the bounding box image based on the color space.

In step S440, the wrong-way driving detector 400 inputs the color histogram of the bounding box image into the classification model (DM). Then, in step S450, the classification model (DM) performs a plurality of operations for applying learned inter-layer weights to the color histogram, thereby calculating a classification value. The classification value includes a probability that the vehicle object in the bounding box image, which is the basis of the color histogram, is a normal driving vehicle and a probability that the vehicle object in the bounding box image is a wrong-way driving vehicle. The classification value may be [normal driving, wrong-way driving]=[0.70, 0.30]. This indicates that the vehicle object has a 70% probability of being a normal driving vehicle and a 30% probability of being a wrong-way driving vehicle. Alternatively, the classification value may be [normal driving, wrong-way driving]=[0.20, 0.80]. This indicates that the vehicle object has a 20% probability of being a normal driving vehicle and an 80% probability of being a wrong-way driving vehicle.

Meanwhile, in step S470, the wrong-way driving detector 400 inputs the color histogram of the bounding box image into the anomaly detection model (ADM). Then, in step S480, the anomaly detection model (ADM) performs a plurality of operations for applying learned inter-layer weights to the color histogram, thereby compressing and then restoring the color histogram to derive a simulated color histogram that simulates the color histogram. For example, the encoder of the anomaly detection model (ADM) performs a plurality of operations for applying learned inter-layer weights to the color histogram to compress the color histogram and derive a latent vector, and the decoder of the anomaly detection model (ADM) performs a plurality of operations for applying learned inter-layer weights to the latent vector derived by the encoder to restore the latent vector and derive the simulated color histogram.

Next, in step S490, the wrong-way driving detector 400 calculates a restoration loss through a loss function. Here, the restoration loss indicates a difference between the input color histogram and the simulated color histogram.

When the restoration loss is calculated, in step S500, the wrong-way driving detector 400 compares the restoration loss with a threshold and thereby derives a second determination result indicating whether the vehicle is wrong-way driving. That is, the wrong-way driving detector 400 checks whether the restoration loss is less than the threshold value (in Equation 3), and if the restoration loss is less than the threshold value, the wrong-way driving detector 400 determines that the vehicle in the bounding box image, which is the basis of the input color histogram, is a normal driving vehicle. On the other hand, if the restoration loss is greater than or equal to the threshold value, the wrong-way driving detector 400 determines that the vehicle in the bounding box image, which is the basis of the input color histogram, is a wrong-way driving vehicle.

Next, in step S510, the wrong-way driving detector 400 may determine whether the vehicle in the bounding box image, which is the basis of the input color histogram, is wrong-way driving, by considering both the first determination result by the classification model (CM) and the second determination result by the anomaly detection model (ADM). In one example, if both the first determination result by the classification model (CM) and the second determination result by the anomaly detection model (ADM) indicate the wrong-way driving vehicle, the wrong-way driving detector 400 may finally determine the vehicle to be wrong-way driving. In another example, if either of the first determination result by the classification model (CM) and the second determination result by the anomaly detection model (ADM) indicate the wrong-way driving vehicle, the wrong-way driving detector 400 may finally determine the vehicle to be wrong-way driving.

Next, in step S520, the notification unit 500 may provide the manager device 30 with information on whether the vehicle is wrong-way driving. Accordingly, it is possible to detect a wrong-way driving vehicle in real time and quickly cope with the risk of wrong-way driving.

In particular, the third embodiment of the present disclosure detects a wrong-way driving vehicle through color histogram analysis, thereby enabling analysis in a single frame only and improving the detection rate of wrong-way driving through the red distribution that appears in vehicle's tail lights at night when image discrimination is difficult.

While the description contains many specific implementation details, these should not be construed as limitations on the scope of the present disclosure or of what may be claimed, but rather as descriptions of features that may be specific to particular embodiments of particular disclosure.

Also, although the description describes that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The description shows the best mode of the present disclosure and provides examples to illustrate the present disclosure and to enable a person skilled in the art to make and use the present disclosure. The present disclosure is not limited by the specific terms used herein. Based on the above-described embodiments, one of ordinary skill in the art can modify, alter, or change the embodiments without departing from the scope of the present disclosure.

Accordingly, the scope of the present disclosure should not be limited by the described embodiments and should be defined by the appended claims.

What is claimed is:

1. A method for detecting a wrong-way driving vehicle, the method comprising:
by a data processor, receiving an image of a vehicle;
by an object detector, deriving a bounding box image, which is an image of a bounding box indicating an area occupied by the vehicle in the received image, using a learned object detection model;
by a wrong-way driving detector, analyzing the bounding box image using a learned classification model to derive a first determination result indicating whether the vehicle is a wrong-way driving vehicle;
by the wrong-way driving detector, analyzing the bounding box image using a learned anomaly detection model to derive a second determination result indicating whether the vehicle is a wrong-way driving vehicle; and
by the wrong-way driving detector, considering both the first determination result and the second determination result to derive a final determination result indicating whether the vehicle is a wrong-way driving vehicle.

2. The method of claim 1, wherein deriving the bounding box image includes:
by the learned object detection model, performing a plurality of operations for applying a plurality of learned inter-layer weights to the received image to detect the bounding box; and
by the object detector, extracting the bounding box image from the received image.

3. The method of claim 1, wherein deriving the first determination result includes:
by the learned classification model, performing a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle; and
by the wrong-way driving detector, deriving the first determination result based on both the probability of a normal driving vehicle and the probability of a wrong-way driving vehicle in the classification value.

4. The method of claim 1, wherein deriving the second determination result includes:
by the learned anomaly detection model, performing a plurality of operations for applying a plurality of learned inter-layer weights to the bounding box image to compress and restore the bounding box image and thereby derive a simulated image that simulates the bounding box image;
by the wrong-way driving detector, calculating a restoration loss indicating a difference between the bounding box image and the simulated image; and
by the wrong-way driving detector, deriving the second determination result based on whether the calculated restoration loss is less than a predetermined threshold.

5. The method of claim 1, further comprising:
before receiving the image of the vehicle,
by a learning unit, preparing learning data including a learning image and a label, the learning image containing a vehicle object, and the label including a ground-truth box indicating an area occupied by the vehicle object in the learning image and a class vector indicating that a class of the object is a vehicle;
by the learning unit, inputting the learning image into an object detection model whose learning is uncompleted;
by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs;
by the learning unit, calculating a composite loss including a difference between the bounding box and the ground-truth box and a difference between the class vector and the predictive vector; and
by the learning unit, performing optimization to modify the weights of the object detection model so that the composite loss is minimized.

6. The method of claim 1, further comprising:
before receiving the image of the vehicle,
by a learning unit, preparing learning data including a learning image and a label, the learning image containing a normal driving vehicle or a wrong-way driving vehicle, and the label distinguishing whether a vehicle in the learning image is a normal driving vehicle or a wrong-way driving vehicle;
by the learning unit, inputting the learning image into a classification model whose learning is uncompleted;
by the classification model, performing a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle;
by the learning unit, calculating a classification loss indicating a difference between the learning classification value and the label; and
by the learning unit, performing optimization to modify the weights of the classification model so that the classification loss is minimized.

7. The method of claim 1, further comprising:
before receiving the image of the vehicle,
by a learning unit, preparing a learning image containing a normal driving vehicle;
by the learning unit, inputting the learning image into an anomaly detection model whose learning is uncompleted;
by the anomaly detection model, performing a plurality of operations for applying untrained inter-layer weights to the learning image to generate a simulated image that simulates the learning image;
by the learning unit, calculating a restoration loss indicating a difference between the learning image and the simulated image; and
by the learning unit, performing optimization to modify the weights of the anomaly detection model so that the restoration loss is minimized.

8. The method of claim 7, further comprising:
before receiving the image of the vehicle and after performing the optimization,
by the learning unit, calculating a threshold value according to Equation θ=μ+(k×σ),
wherein μ denotes an average of the mean squared error between a plurality of test images and a plurality of simulated images corresponding to the plurality of test images,
σ denotes a standard deviation of the mean squared error between a plurality of test images and a plurality of simulated images corresponding to the plurality of test images, and
k denotes a weight for the standard deviation.

9. An apparatus for detecting a wrong-way driving vehicle, the apparatus comprising:
a data processor configured to receive an image of a vehicle;
an object detector configured to derive a bounding box image, which is an image of a bounding box indicating an area occupied by the vehicle in the received image, using a learned object detection model; and
a wrong-way driving detector configured to:
analyze the bounding box image using a learned classification model to derive a first determination result indicating whether the vehicle is a wrong-way driving vehicle,
analyze the bounding box image using a learned anomaly detection model to derive a second determination result indicating whether the vehicle is a wrong-way driving vehicle, and
consider both the first determination result and the second determination result to derive a final determination result indicating whether the vehicle is a wrong-way driving vehicle.

10. The apparatus of claim 9, wherein the learned object detection model performs a plurality of operations for applying a plurality of learned inter-layer weights to the received image to detect the bounding box, and
the object detector is configured to extract the bounding box image from the received image.

11. The apparatus of claim 9, wherein the learned classification model performs a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle, and
the wrong-way driving detector is configured to derive the first determination result based on both the probability of a normal driving vehicle and the probability of a wrong-way driving vehicle in the classification value.

12. The apparatus of claim 9, wherein the learned anomaly detection model performs a plurality of operations for applying a plurality of learned inter-layer weights to the bounding box image to compress and restore the bounding box image and thereby derive a simulated image that simulates the bounding box image, and
the wrong-way driving detector is configured to:
calculate a restoration loss indicating a difference between the bounding box image and the simulated image, and
derive the second determination result based on whether the calculated restoration loss is less than a predetermined threshold.

13. The apparatus of claim 9, further comprising:
a learning unit configured to:
prepare learning data including a learning image and a label, the learning image containing a vehicle object, and the label including a ground-truth box indicating an area occupied by the vehicle object in the learning image and a class vector indicating that a class of the object is a vehicle,
input the learning image into an object detection model whose learning is uncompleted,
when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs,
calculate a composite loss including a difference between the bounding box and the ground-truth box and a difference between the class vector and the predictive vector, and
perform optimization to modify the weights of the object detection model so that the composite loss is minimized.

14. The apparatus of claim 9, further comprising:
a learning unit configured to:
prepare learning data including a learning image and a label, the learning image containing a normal driving vehicle or a wrong-way driving vehicle, and the label distinguishing whether a vehicle in the learning image is a normal driving vehicle or a wrong-way driving vehicle,
input the learning image into a classification model whose learning is uncompleted,
when the classification model performs a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle,
calculate a classification loss indicating a difference between the learning classification value and the label, and
perform optimization to modify the weights of the classification model so that the classification loss is minimized.

15. The apparatus of claim 9, further comprising:
a learning unit configured to:
prepare a learning image containing a normal driving vehicle,
input the learning image into an anomaly detection model whose learning is uncompleted,
when the anomaly detection model performs a plurality of operations for applying untrained inter-layer weights to the learning image to generate a simulated image that simulates the learning image,
calculate a restoration loss indicating a difference between the learning image and the simulated image, and
perform optimization to modify the weights of the anomaly detection model so that the restoration loss is minimized.

16. The apparatus of claim 15, wherein the learning unit calculates a threshold value according to Equation θ=μ+(k×σ),
wherein μ denotes an average of the mean squared error between a plurality of test images and a plurality of simulated images corresponding to the plurality of test images,
σ denotes a standard deviation of the mean squared error between a plurality of test images and a plurality of simulated images corresponding to the plurality of test images, and
k denotes a weight for the standard deviation.

17. A method for tracking a wrong-way driving vehicle, the method comprising:
by a data processor, receiving an image from a first sensor device among a plurality of sensor devices arranged at predetermined intervals along a road and including the first sensor device and a plurality of second sensor devices;
by a tracking unit, analyzing the image received from the first sensor device to determine whether a wrong-way driving vehicle is detected in the received image;
by the tracking unit, when the wrong-way driving vehicle is detected in the received image, receiving images from the plurality of second sensor devices through the data processor; and
by the tracking unit, analyzing the images received from the plurality of second sensor devices to continuously detect the wrong-way driving vehicle, thereby tracking the wrong-way driving vehicle.

18. The method of claim 17, wherein tracking the wrong-way driving vehicle includes:
by the tracking unit, receiving the images from one or more second sensor devices in the order of proximity to the first sensor device among the plurality of second sensor devices arranged in a direction of travel of the wrong-way driving vehicle; and
by the tracking unit, analyzing the images received from the one or more second sensor devices through one or more learning models to detect the wrong-way driving vehicle in the received images.

19. The method of claim 17, wherein determining whether a wrong-way driving vehicle is detected includes:
by an object detector, deriving a bounding box image, which is an image of a bounding box indicating an area occupied by the vehicle in the received image, using a learned object detection model;
by a wrong-way driving detector, analyzing the bounding box image using a learned classification model to derive a first determination result indicating whether the vehicle is a wrong-way driving vehicle;
by the wrong-way driving detector, analyzing the bounding box image using a learned anomaly detection model to derive a second determination result indicating whether the vehicle is a wrong-way driving vehicle; and
by the wrong-way driving detector, considering both the first determination result and the second determination result to derive a final determination result indicating whether the vehicle is a wrong-way driving vehicle.

20. The method of claim 19, wherein deriving the bounding box image includes:
by the learned object detection model, performing a plurality of operations for applying a plurality of learned inter-layer weights to the received image to detect the bounding box; and
by the object detector, extracting the bounding box image from the received image.

21. The method of claim 19, wherein deriving the first determination result includes:
by the learned classification model, performing a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle; and
by the wrong-way driving detector, deriving the first determination result based on both the probability of a normal driving vehicle and the probability of a wrong-way driving vehicle in the classification value.

22. The method of claim 19, wherein deriving the second determination result includes:
by the learned anomaly detection model, performing a plurality of operations for applying a plurality of learned inter-layer weights to the bounding box image to compress and restore the bounding box image and thereby derive a simulated image that simulates the bounding box image;
by the wrong-way driving detector, calculating a restoration loss indicating a difference between the bounding box image and the simulated image; and
by the wrong-way driving detector, deriving the second determination result based on whether the calculated restoration loss is less than a predetermined threshold.

23. The method of claim 17, further comprising:
before receiving the image of the vehicle,
by a learning unit, preparing learning data including a learning image and a label, the learning image containing a vehicle object, and the label including a ground-truth box indicating an area occupied by the vehicle object in the learning image and a class vector indicating that a class of the object is a vehicle;
by the learning unit, inputting the learning image into an object detection model whose learning is uncompleted;
by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs;
by the learning unit, calculating a composite loss including a difference between the bounding box and the ground-truth box and a difference between the class vector and the predictive vector; and
by the learning unit, performing optimization to modify the weights of the object detection model so that the composite loss is minimized.

24. The method of claim 17, further comprising:
before receiving the image of the vehicle,
by a learning unit, preparing learning data including a learning image and a label, the learning image containing a normal driving vehicle or a wrong-way driving vehicle, and the label distinguishing whether a vehicle in the learning image is a normal driving vehicle or a wrong-way driving vehicle;
by the learning unit, inputting the learning image into a classification model whose learning is uncompleted;
by the classification model, performing a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle;
by the learning unit, calculating a classification loss indicating a difference between the learning classification value and the label; and
by the learning unit, performing optimization to modify the weights of the classification model so that the classification loss is minimized.

25. The method of claim 17, further comprising:
before receiving the image of the vehicle,
by a learning unit, preparing a learning image containing a normal driving vehicle;
by the learning unit, inputting the learning image into an anomaly detection model whose learning is uncompleted;
by the anomaly detection model, performing a plurality of operations for applying untrained inter-layer weights to the learning image to generate a simulated image that simulates the learning image;
by the learning unit, calculating a restoration loss indicating a difference between the learning image and the simulated image; and
by the learning unit, performing optimization to modify the weights of the anomaly detection model so that the restoration loss is minimized.

26. The method of claim 25, further comprising:
before receiving the image of the vehicle and after performing the optimization,
by the learning unit, calculating a threshold value according to Equation θ=μ+(k×σ),
wherein μ denotes an average of the mean squared error between a plurality of test images and a plurality of simulated images corresponding to the plurality of test images,
σ denotes a standard deviation of the mean squared error between a plurality of test images and a plurality of simulated images corresponding to the plurality of test images, and
k denotes a weight for the standard deviation.

27. An apparatus for tracking a wrong-way driving vehicle, the apparatus comprising:
a data processor configured to receive an image from a first sensor device among a plurality of sensor devices arranged at predetermined intervals along a road and including the first sensor device and a plurality of second sensor devices; and
a tracking unit configured to:
analyze the image received from the first sensor device to determine whether a wrong-way driving vehicle is detected in the received image,
when the wrong-way driving vehicle is detected in the received image, receive images from the plurality of second sensor devices through the data processor, and
analyze the images received from the plurality of second sensor devices to continuously detect the wrong-way driving vehicle, thereby tracking the wrong-way driving vehicle.

28. The apparatus of claim 27, wherein the tracking unit is configured to:
receive the images from one or more second sensor devices in the order of proximity to the first sensor device among the plurality of second sensor devices arranged in a direction of travel of the wrong-way driving vehicle, and
analyze the images received from the one or more second sensor devices through one or more learning models to detect the wrong-way driving vehicle in the received images.

29. The apparatus of claim 27, wherein the tracking unit includes:
an object detector configured to derive a bounding box image, which is an image of a bounding box indicating an area occupied by the vehicle in the received image, using a learned object detection model; and
a wrong-way driving detector configured to:
analyze the bounding box image using a learned classification model to derive a first determination result indicating whether the vehicle is a wrong-way driving vehicle,
analyze the bounding box image using a learned anomaly detection model to derive a second determination result indicating whether the vehicle is a wrong-way driving vehicle, and
consider both the first determination result and the second determination result to derive a final determination result indicating whether the vehicle is a wrong-way driving vehicle.

30. The apparatus of claim 29, wherein the learned object detection model performs a plurality of operations for applying a plurality of learned inter-layer weights to the received image to detect the bounding box, and
the object detector is configured to extract the bounding box image from the received image.

31. The apparatus of claim 29, wherein the learned classification model performs a plurality of operations for applying a plurality of learned inter-layer weights to the bounding box image to calculate a classification value indicating a probability that the vehicle in the bounding box image is a normal driving vehicle and a probability that the vehicle in the bounding box image is a wrong-way driving vehicle, and
the wrong-way driving detector is configured to derive the first determination result based on both the probability of a normal driving vehicle and the probability of a wrong-way driving vehicle in the classification value.

32. The apparatus of claim 29, wherein the learned anomaly detection model performs a plurality of operations for applying a plurality of learned inter-layer weights to the bounding box image to compress and restore the bounding box image and thereby derive a simulated image that simulates the bounding box image, and
the wrong-way driving detector is configured to:
calculate a restoration loss indicating a difference between the bounding box image and the simulated image, and
derive the second determination result based on whether the calculated restoration loss is less than a predetermined threshold.

33. The apparatus of claim 27, further comprising:
a learning unit configured to:
prepare learning data including a learning image and a label, the learning image containing a vehicle object, and the label including a ground-truth box indicating an area occupied by the vehicle object in the learning image and a class vector indicating that a class of the object is a vehicle,
input the learning image into an object detection model whose learning is uncompleted,
when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs,
calculate a composite loss including a difference between the bounding box and the ground-truth box and a difference between the class vector and the predictive vector, and
perform optimization to modify the weights of the object detection model so that the composite loss is minimized.

34. The apparatus of claim 27, further comprising:
a learning unit configured to:
prepare learning data including a learning image and a label, the learning image containing a normal driving vehicle or a wrong-way driving vehicle, and the label distinguishing whether a vehicle in the learning image is a normal driving vehicle or a wrong-way driving vehicle,
input the learning image into a classification model whose learning is uncompleted,
when the classification model performs a plurality of operations for applying untrained inter-layer weights to the learning image to calculate a learning classification value indicating a probability that the vehicle in the learning image is a normal driving vehicle and a probability that the vehicle in the learning image is a wrong-way driving vehicle,
calculate a classification loss indicating a difference between the learning classification value and the label, and
perform optimization to modify the weights of the classification model so that the classification loss is minimized.

35. The apparatus of claim 27, further comprising:
a learning unit configured to:
prepare a learning image containing a normal driving vehicle,
input the learning image into an anomaly detection model whose learning is uncompleted,
when the anomaly detection model performs a plurality of operations for applying untrained inter-layer weights to the learning image to generate a simulated image that simulates the learning image,
calculate a restoration loss indicating a difference between the learning image and the simulated image, and
perform optimization to modify the weights of the anomaly detection model so that the restoration loss is minimized.

36. The apparatus of claim 35, wherein the learning unit calculates a threshold value according to Equation θ=μ+(k×σ),
wherein μ denotes an average of the mean squared error between a plurality of test images and a plurality of simulated images corresponding to the plurality of test images,
σ denotes a standard deviation of the mean squared error between a plurality of test images and a plurality of simulated images corresponding to the plurality of test images, and
k denotes a weight for the standard deviation.

37. A method for detecting a wrong-way driving vehicle, the method comprising:
by a data processor, receiving an image of a vehicle driving a road;
by an object detector, deriving a bounding box image, which is an image of a bounding box indicating an area occupied by the vehicle in the received image, using a learned object detection model;
by a histogram generator, deriving a color histogram from the bounding box image; and
by a wrong-way driving detector, identifying a difference in color distribution between a front and rear of the vehicle through analysis of the color histogram to determine whether the vehicle is a wrong-way driving vehicle.

38. The method of claim 37, wherein determining whether the vehicle is a wrong-way driving vehicle includes:
by the wrong-way driving detector, analyzing the color histogram using a learned classification model to derive a first determination result indicating whether the vehicle is a wrong-way driving vehicle;
by the wrong-way driving detector, analyzing the color histogram using a learned anomaly detection model to derive a second determination result indicating whether the vehicle is a wrong-way driving vehicle; and
by the wrong-way driving detector, considering both the first determination result and the second determination result to derive a final determination result indicating whether the vehicle is a wrong-way driving vehicle.

39. The method of claim 38, wherein deriving the first determination result includes:
by the learned classification model, performing a plurality of operations for applying a plurality of learned inter-layer weights to the color histogram to calculate a classification value indicating a probability that the vehicle in the bounding box image is a normal driving vehicle and a probability that the vehicle in the bounding box image is a wrong-way driving vehicle; and
by the wrong-way driving detector, deriving the first determination result based on both the probability of a normal driving vehicle and the probability of a wrong-way driving vehicle in the classification value.

40. The method of claim 39, wherein deriving the second determination result includes:
by the learned anomaly detection model, performing a plurality of operations for applying a plurality of learned inter-layer weights to the color histogram to compress and restore the bounding box image and thereby derive a simulated color histogram that simulates the color histogram;
by the wrong-way driving detector, calculating a restoration loss indicating a difference between the color histogram and the simulated color histogram; and
by the wrong-way driving detector, deriving the second determination result based on whether the calculated restoration loss is less than a predetermined threshold.

41. The method of claim 37, wherein deriving the bounding box image includes:
by the learned object detection model, performing a plurality of operations for applying a plurality of learned inter-layer weights to the received image to detect the bounding box; and
by the object detector, extracting the bounding box image from the received image.

42. The method of claim 37, further comprising:
before receiving the image of the vehicle,
by a learning unit, preparing learning data including a learning color histogram of an image containing a normal driving vehicle or a wrong-way driving vehicle, the learning data further including a label distinguishing whether a vehicle in the learning color histogram is a normal driving vehicle or a wrong-way driving vehicle;
by the learning unit, inputting the learning color histogram into a classification model whose learning is uncompleted;
by the classification model, performing a plurality of operations for applying untrained inter-layer weights to the learning color histogram to calculate a learning classification value indicating a probability that the vehicle in the learning color histogram is a normal driving vehicle and a probability that the vehicle in the learning color histogram is a wrong-way driving vehicle;
by the learning unit, calculating a classification loss indicating a difference between the learning classification value and the label; and
by the learning unit, performing optimization to modify the weights of the classification model so that the classification loss is minimized.

43. The method of claim 37, further comprising:
before receiving the image of the vehicle,
by a learning unit, preparing a learning color histogram of an image containing a normal driving vehicle;
by the learning unit, inputting the learning color histogram into an anomaly detection model whose learning is uncompleted;
by the anomaly detection model, performing a plurality of operations for applying untrained inter-layer weights to the learning color histogram to generate a simulated color histogram that simulates the learning color histogram;
by the learning unit, calculating a restoration loss indicating a difference between the learning color histogram and the simulated color histogram; and
by the learning unit, performing optimization to modify the weights of the anomaly detection model so that the restoration loss is minimized.

44. The method of claim 43, further comprising:
before receiving the image of the vehicle and after performing the optimization,
by the learning unit, calculating a threshold value according to Equation θ=μ+(k×σ),
wherein μ denotes an average of the mean squared error between a plurality of test color histograms and a plurality of simulated color histograms corresponding to the plurality of test color histograms,
σ denotes a standard deviation of the mean squared error between a plurality of test color histograms and a plurality of simulated color histograms corresponding to the plurality of test color histograms, and
k denotes a weight for the standard deviation.

45. The method of claim 37, further comprising:
before receiving the image of the vehicle,
by a learning unit, preparing learning data including a learning image and a label, the learning image containing a vehicle object, and the label including a ground-truth box indicating an area occupied by the vehicle object in the learning image and a class vector indicating that a class of the object is a vehicle;
by the learning unit, inputting the learning image into an object detection model whose learning is uncompleted;
by the object detection model, performing a plurality of operations for applying untrained inter-layer weights to the learning image to calculate a learning detection value that includes a bounding box indicating an area occupied by a vehicle in the learning image and a predictive vector for predicting a class to which the object in the bounding box belongs;
by the learning unit, calculating a composite loss including a difference between the bounding box and the ground-truth box and a difference between the class vector and the predictive vector; and
by the learning unit, performing optimization to modify the weights of the object detection model so that the composite loss is minimized.

46. An apparatus for detecting a wrong-way driving vehicle, the apparatus comprising:
a data processor configured to receive an image of a vehicle driving a road;
an object detector configured to derive a bounding box image, which is an image of a bounding box indicating an area occupied by the vehicle in the received image, using a learned object detection model;
a histogram generator configured to derive a color histogram from the bounding box image; and
a wrong-way driving detector configured to identify a difference in color distribution between a front and rear of the vehicle through analysis of the color histogram to determine whether the vehicle is a wrong-way driving vehicle.

47. The apparatus of claim 46, wherein the wrong-way driving detector is configured to:
analyze the color histogram using a learned classification model to derive a first determination result indicating whether the vehicle is a wrong-way driving vehicle,
analyze the color histogram using a learned anomaly detection model to derive a second determination result indicating whether the vehicle is a wrong-way driving vehicle, and
consider both the first determination result and the second determination result to derive a final determination result indicating whether the vehicle is a wrong-way driving vehicle.

48. The apparatus of claim 47, wherein the learned classification model performs a plurality of operations for applying a plurality of learned inter-layer weights to the color histogram to calculate a classification value indicating a probability that the vehicle in the bounding box image is a normal driving vehicle and a probability that the vehicle in the bounding box image is a wrong-way driving vehicle, and
the wrong-way driving detector is configured to derive the first determination result based on both the probability of a normal driving vehicle and the probability of a wrong-way driving vehicle in the classification value.

49. The apparatus of claim 47, wherein the learned anomaly detection model performs a plurality of operations for applying a plurality of learned inter-layer weights to the color histogram to compress and restore the bounding box image and thereby derive a simulated color histogram that simulates the color histogram, and
the wrong-way driving detector is configured to:
calculate a restoration loss indicating a difference between the color histogram and the simulated color histogram, and
derive the second determination result based on whether the calculated restoration loss is less than a predetermined threshold.

50. The apparatus of claim 46, wherein the learned object detection model performs a plurality of operations for applying a plurality of learned inter-layer weights to the received image to detect the bounding box, and
the object detector is configured to extract the bounding box image from the received image.

51. The apparatus of claim 46, further comprising:
a learning unit configured to:
prepare learning data including a learning color histogram of an image containing a normal driving vehicle or a wrong-way driving vehicle, the learning data further including a label distinguishing whether a vehicle in the learning color histogram is a normal driving vehicle or a wrong-way driving vehicle,
input the learning color histogram into a classification model whose learning is uncompleted,
when the classification model performs a plurality of operations for applying untrained inter-layer weights to the learning color histogram to calculate a learning classification value indicating a probability that the vehicle in the learning color histogram is a normal driving vehicle and a probability that the vehicle in the learning color histogram is a wrong-way driving vehicle,
calculate a classification loss indicating a difference between the learning classification value and the label, and
perform optimization to modify the weights of the classification model so that the classification loss is minimized.

52. The apparatus of claim 46, further comprising:
a learning unit configured to:
prepare a learning color histogram of an image containing a normal driving vehicle,
input the learning color histogram into an anomaly detection model whose learning is uncompleted,
when the anomaly detection model performs a plurality of operations for applying untrained inter-layer weights to the learning color histogram to generate a simulated color histogram that simulates the learning color histogram,
calculate a restoration loss indicating a difference between the learning color histogram and the simulated color histogram, and
perform optimization to modify the weights of the anomaly detection model so that the restoration loss is minimized.

53. The apparatus of claim 52, wherein the learning unit calculates a threshold value according to Equation θ=μ+(k×σ),
wherein μ denotes an average of the mean squared error between a plurality of test color histograms and a plurality of simulated color histograms corresponding to the plurality of test color histograms,
σ denotes a standard deviation of the mean squared error between a plurality of test color histograms and a plurality of simulated color histograms corresponding to the plurality of test color histograms, and
k denotes a weight for the standard deviation.

54. The apparatus of claim 46, further comprising:
a learning unit configured to:
prepare learning data including a learning image and a label, the learning image containing a vehicle object, and the label including a ground-truth box indicating an area occupied by the vehicle object in the learning image and a class vector indicating that a class of the object is a vehicle,
input the learning image into an object detection model whose learning is uncompleted,
when the object detection model performs a plurality of operations for applying untrained inter-layer weights to the learning image to calculate a learning detection value that includes a bounding box indicating an area occupied by a vehicle in the learning image and a predictive vector for predicting a class to which the object in the bounding box belongs,
calculate a composite loss including a difference between the bounding box and the ground-truth box and a difference between the class vector and the predictive vector, and
perform optimization to modify the weights of the object detection model so that the composite loss is minimized.
